(19) United States
(12) Patent Application Publication
(10) Pub. No.: US 2026/0064427 A1
(43) Pub. Date: Mar. 5, 2026

(54) SEQUENTIALLY CLEARING SUBSETS OF PREDICTION STATE OF PROCESSORS WHILE CONTINUING TO PROCESS INSTRUCTIONS

(71) Applicant: Intel Corporation, Santa Clara, CA (US)

(72) Inventors: Mathew Lowes, Austin, TX (US); Martin Licht, Round Rock, TX (US); Priyanka Gupta, Hillsboro, OR (US); Jared Warner Stark, IV, Portland, OR (US); Jonathan Combs, Austin, TX (US)

(73) Assignee: Intel Corporation, Santa Clara, CA (US)

(21) Appl. No.: 18/821,877

(22) Filed: Aug. 30, 2024

(51) Int. Cl. G06F 9/38; G06F 9/30

(52) U.S. Cl. CPC G06F 9/3844; G06F 9/30047; G06F 9/30145

(57) ABSTRACT

A method of an aspect includes processing instructions with a processor, making predictions associated with some of the instructions based on prediction state, clearing a plurality of subsets of the prediction state sequentially, and continuing the processing of the instructions while the plurality of the subsets of the prediction state are being cleared. Other methods, processors, and systems are also disclosed.

### BACKGROUND

### Background Information

Programs or code executed by processors typically contains control flow transfer instructions known as branch instructions. Branch instructions are sometimes referred to as jump instructions. The branch or jump instructions cause branches or jumps to be taken in the programs or code (e.g., branching or jumping forward or backwards in the programs or code over other instructions). There are different types of branch or jump instructions. Indirect or computed branch or jump instructions do not directly specify the address of the next instruction to be executed, but rather have an operand or argument (e.g., indicate a register) where the address is stored. Conditional branch or jump instructions cause the flow of execution to branch or jump conditionally in one of two possible directions. These two directions are often called a “taken path” and a “not taken path”. The “not taken path” commonly leads to the next sequential instruction in the code being executed, whereas the “taken path” commonly jumps or branches forward or backward over one or more intervening instructions to a non-sequential target instruction. Whether the branches or jumps are taken or not taken depends upon the evaluation of a condition associated with the conditional branch or jump instructions (e.g., whether or not the condition is met).

One challenge is that it may take some time for the condition to be evaluated and waiting to execute the conditional branch or jump instruction until the condition is evaluated may unnecessarily limit performance. Instead, to help improve performance, most modern processors have a branch prediction unit to help predict the directions of conditional branch or jump instructions before the conditions have been evaluated. The actual directions of the conditional branch or jump instructions will not be known definitively until the condition has actually been evaluated at a later time (e.g., in a later stage of the pipeline). However, the branch prediction unit may use one or more branch prediction mechanisms and associated branch prediction state to predict the directions (e.g., the most likely directions) of the conditional branch or jump instructions before the conditions are evaluated. This may allow execution to continue by speculatively fetching and executing additional instructions along the predicted direction while the condition is being evaluated.

Ultimately the predicted direction will either turn out to be correct or incorrect. If the predicted direction turns out to be correct, then the results and/or state of the speculatively executed instructions may be utilized. In this case, the performance and speed of the processor will generally have been increased due to greater utilization of pipeline stages that would otherwise have been dormant, or at least underutilized, while waiting for the evaluation of the condition of the conditional branch or jump instruction. However, if instead the predicted direction turns out to be incorrect (e.g., was miss-predicted by the branch prediction unit), then any results and/or state from the instructions speculatively executed beyond the conditional branch or jump instruction may be discarded. For example, the pipeline may be flushed to discard speculative instructions currently in flight in the pipeline and execution may be rewound back to the conditional branch or jump instruction that was miss-predicted. Further execution may then be restarted along the alternate, now correctly-known, branch direction. This outcome (e.g., misprediction and pipeline flush) is generally undesirable, since it tends to incur power consumption without improving performance.

### BRIEF DESCRIPTION OF THE DRAWINGS

Various examples in accordance with the present disclosure will be described with reference to the drawings, in which:

FIG. 1 is a block flow diagram of an embodiment of a method of clearing prediction state of a processor.

FIG. 2A is a block diagram of an embodiment of a processor.

FIG. 2B is a block diagram of a first example embodiment of branch history table.

FIG. 2C is a block diagram of a second example embodiment of branch history table.

FIG. 3 is a block diagram of a detailed example embodiment of a processor having a detailed example embodiment of a front-end unit and a detailed example embodiment of a back-end unit.

FIG. 4 is a block diagram of an embodiment of a front-end unit having a prediction unit, a first circuitry to sequentially clear a plurality of subsets of prediction state, and a second circuitry to control how the prediction unit makes predictions while the plurality of the subsets of the prediction state are being cleared.

FIG. 5 is a circuit diagram of a detailed example embodiment of circuitry to sequentially clear a plurality of subsets of prediction state and circuitry to control how the prediction unit makes predictions while the subsets of the prediction state are being cleared.

FIG. 6 illustrates an example computing system.

FIG. 7 illustrates a block diagram of an example processor and/or System on a Chip (SoC) that may have one or more cores and an integrated memory controller.

FIG. 8(A) is a block diagram illustrating both an example in-order pipeline and an example register renaming, out-of-order issue/execution pipeline according to examples.

FIG. 8(B) is a block diagram illustrating both an example in-order architecture core and an example register renaming, out-of-order issue/execution architecture core to be included in a processor according to examples.

FIG. 9 illustrates examples of execution unit(s) circuitry.

FIG. 10 is a block diagram of a register architecture according to some examples.

FIG. 11 illustrates examples of an instruction format.

FIG. 12 illustrates examples of an addressing information field.

FIG. 13 illustrates examples of a first prefix.

FIGS. 14(A)-(D) illustrate examples of how the R, X, and B fields of the first prefix in FIG. 13 are used.

FIGS. 15(A)-(B) illustrate examples of a second prefix.

FIG. 16 illustrates examples of a third prefix.

FIG. 17 is a block diagram illustrating the use of a software instruction converter to convert binary instructions in a source instruction set architecture to binary instructions in a target instruction set architecture according to examples.

### DETAILED DESCRIPTION OF EMBODIMENTS

Disclosed herein are embodiments of apparatus, methods, systems, and non-transitory computer-readable storage media to clear prediction state of a prediction unit of a processor. In the following description, numerous specific details are set forth (e.g., specific sequences of operations, processor configurations, microarchitectural details, circuitry implementations, etc.). However, embodiments may be practiced without these specific details. In other instances, well-known circuits, structures, and techniques have not been shown in detail to avoid obscuring the understanding of the description.

In recent years various side-channel security vulnerabilities have been identified where there is a potential risk of information (e.g., secret or confidential information) being unintentionally leaked or revealed through a side channel exploit. Various types of prediction units are potentially susceptible to such side-channel security vulnerabilities via their prediction state. In the case of a branch prediction unit, there is the possibly of attacks that use the identification (e.g., optionally stew-based indexing as one example) of conditional branches and rely on being able to use the state of the conditional branch predictors left over from running a process in a secure mode prior to the attack process to perform side channel transient execution attacks. [As an aside to provide some explanation, stew generally represents a type of history used by certain branch predictors. Representatively, the stew may be a value calculated by combining taken branch directions and branch addresses for a certain number of the last branches according to a function. As one non-limiting example, an updated stew value may be calculated by exclusive-ORing a current stew value with least significant bits of the branch address and then shifting in the current branch outcome bit (e.g., 0 for not taken and 1 for taken)]. Returning again to the discussion of possible side channel transient execution attacks, as one example, prediction state generated by first code executing in a first context or mode could potentially be leaked or revealed to second code executed in a second, different context or mode, which could potentially allow the second code to learn the predictions (e.g., branch predictions or control flow) of the first code. As such, the prediction state may represent secret or confidential information of the first code, context, or mode that should not be leaked or revealed to the second code, context, or mode. As another example, second code executing in a second context or mode could potentially influence the prediction state used for first code executed in a first context or mode, which could potentially allow the second code to control the predictions (e.g., branch predictions or control flow) of the first code. As such, there are times when it may be appropriate to clear the prediction state generated for one code, context, or mode so that it is not used by another code, context, or mode.

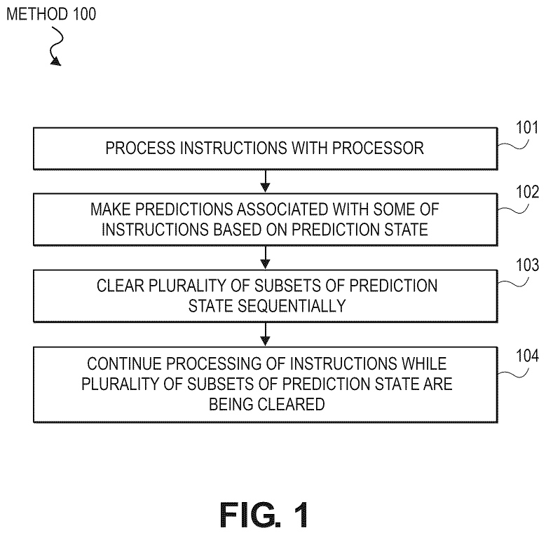

FIG. 1 is a block flow diagram of an embodiment of a method 100 of clearing prediction state of a processor. At block 101, instructions are processed with the processor. For example, this may include fetching instructions, decoding instructions, executing the instructions to perform operations corresponding to the instructions, etc.

At block 102, predictions associated with some of the instructions are made based on prediction state. For example, in some embodiments, the predictions may be branch predictions associated with branch instructions (e.g., conditional branch predictions, indirect branch predictions, etc.), memory renaming predictions associated with instructions that use renamed registers, or other types of predictions.

At block 103, a plurality of subsets of the prediction state may be cleared sequentially. In some embodiments, the clearing of the prediction state may optionally be used upon switching to a new code, context, or mode and/or in response to a switch from one code, context, or mode to another to help protect against side-channel security vulnerabilities and/or to help reduce the risk of leaking prediction state to a different code, context, or mode. For example, changing to the new code, context, or mode may include changing from one application to another (e.g., changing application space identifiers (ASIDs)), changing from one virtual machine (VM) to another (e.g., changing virtual machine identifiers (VMIDs)), VM exits or VM enters, changing from privilege level to user level, entering or exiting a protected execution environment, in some cases changing thread identifiers, etc. In other embodiments, the clearing of the prediction state may optionally be used at various other times, such as, for example, to initialize the prediction state upon a cold reset or boot, a warm reset or boot, when resuming execution from a C6 sleep state or other light sleep state, or to change or otherwise clean prediction state during debugging or other testing.

In some embodiments, the clearing of the plurality of subsets of the prediction state may include clearing a plurality of entries (e.g., distinct entries, individual entries, discrete entries, sequential entries, sequentially indexed entries, all entries, all entries for a certain context or mode, etc.) of an array or table of prediction state sequentially. As one non-limiting example, a branch prediction unit may have a table or array having 256 entries storing branch prediction state, and in cases where all the entries are to be cleared, then this may optionally include clearing entry 0, then clearing entry 1, then clearing entry 2, and so on, until finally clearing entry 255. Alternatively, the entries may optionally be cleared in reverse order or according to other orders. In other embodiments, the clearing of the plurality of subsets of the prediction state may include clearing a plurality of portions (e.g., distinct portions, individual portions, discrete portions, all portions, all portions for a certain context or mode, etc.) of prediction information (e.g., stew-based prediction information as will be discussed later) stored or held in flip flops or other such circuitry. In still other embodiments, the clearing of the plurality of subsets of the prediction state may include clearing a plurality of portions (e.g., distinct portions, individual portions, discrete portions, all portions, all portions for a certain context or mode, etc.) of least recently used and/or most recently used information and/or round robin information used to select structures for replacement. In some embodiments, the clearing of the plurality of the subsets of the prediction state may include changing or otherwise causing the plurality of the subsets of the prediction state to have an initialization state, although as discussed further below this is only one example.

At block 104, the processing of the instructions continues while the plurality of the subsets of the prediction state are being cleared. In some embodiments, this may include fetching additional instructions instruction, decoding the additional instructions, and performing operations corresponding to the additional instructions. In some embodiments, this may optionally include other types of processing, such as, for example, issuing and servicing instruction cache misses, performing page table walks for instruction translation lookaside buffer (TLB) misses, or other types of processing.

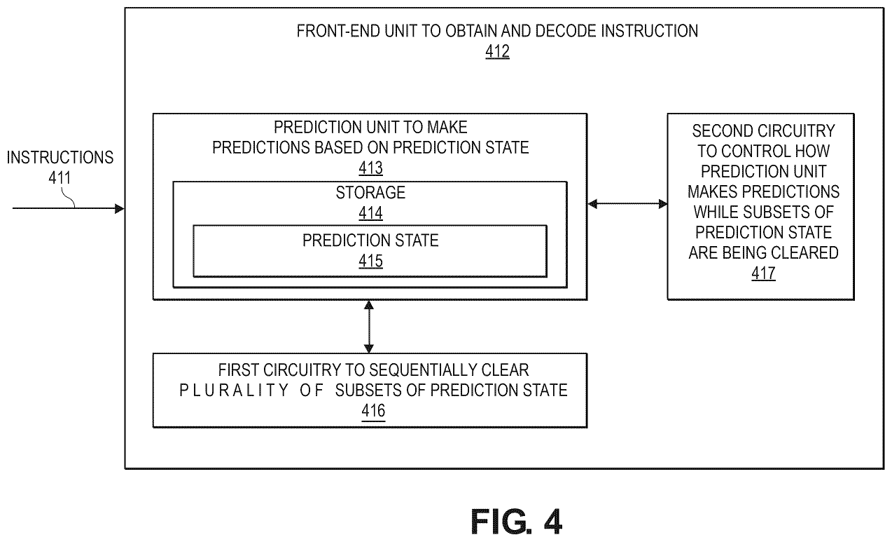

The method 100 has been described in a relatively basic form, but operations may optionally be added to and/or removed from the method. For example, in some embodiments, the method may also optionally include controlling how predictions are made while the plurality of the subsets of the prediction state are cleared sequentially. In some cases, this may include preventing the predictions from being made based on the prediction state. In some embodiments, any of the various approaches discussed further below in conjunction with FIG. 4 may optionally be used.

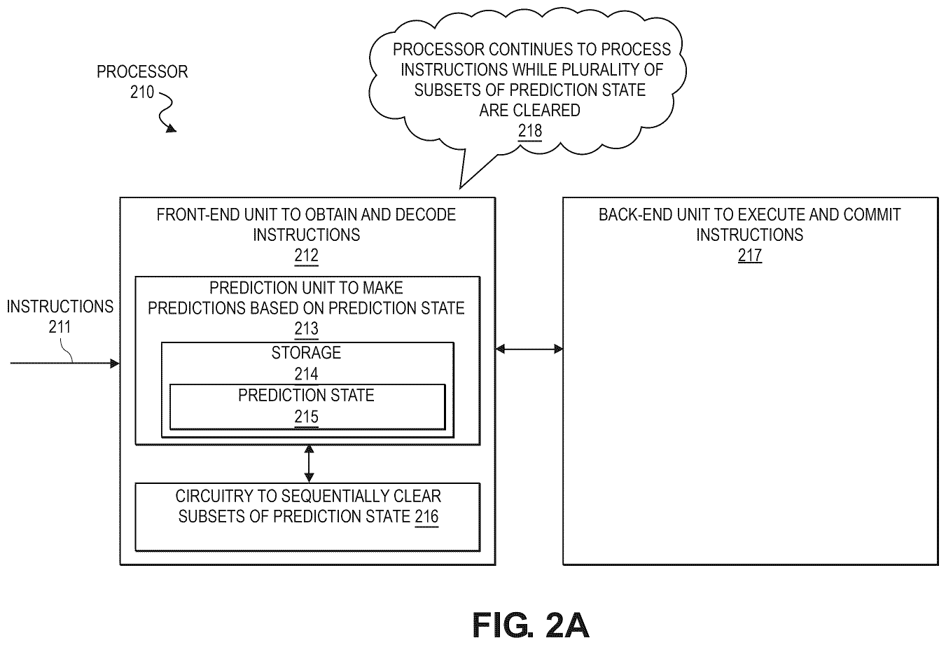

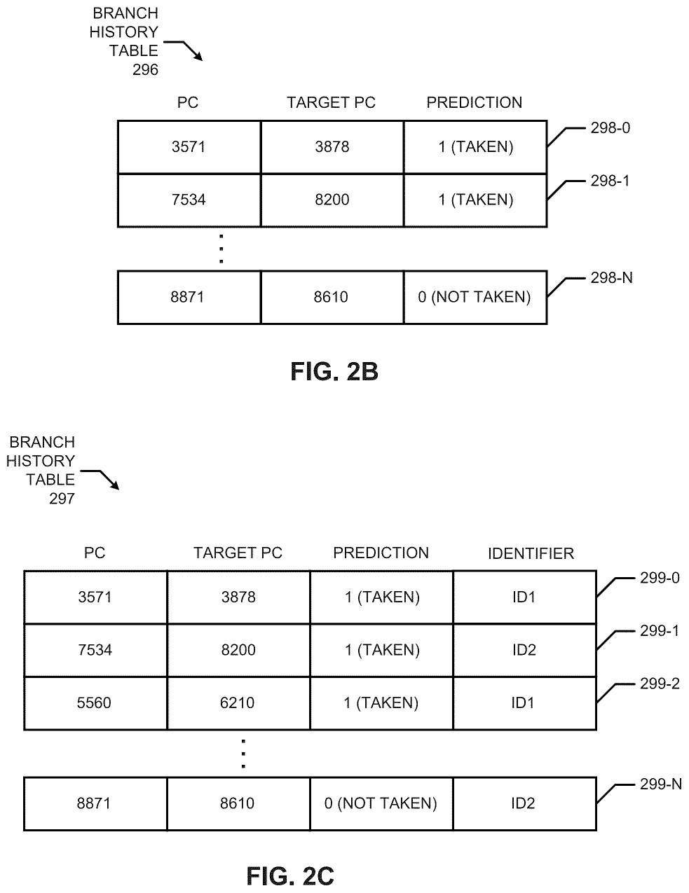

FIG. 2A is a block diagram of an embodiment of a processor 210. In some embodiments, the processor may perform the method 100 of FIG. 1. The components, features, and specific optional details described herein for the processor 210 may optionally apply to the method 100. Alternatively, the method 100 may be performed by a different processor. Also, the processor 210 may perform methods different than the method 100.

In some embodiments, the processor may be a general-purpose processor (e.g., a general-purpose microprocessor or central processing unit (CPU) of the type used in desktops, laptops, servers, and other computer systems). Alternatively, the processor may be a special-purpose processor. Examples of suitable special-purpose processors include, but are not limited to, coprocessors, graphics processors, network processors, communications processors, machine-learning processors, artificial intelligence processors, cryptographic processors, embedded processors, digital signal processors (DSPs), and controllers (e.g., microcontrollers). The processor may use either in-order or out-of-order execution. The processor may have any of various complex instruction set computing (CISC) architectures, reduced instruction set computing (RISC) architectures, very long instruction word (VLIW) architectures, hybrid architectures, other types of architectures, or have a combination of different architectures (e.g., different cores may have different architectures). In some embodiments, the processor may include (e.g., be disposed on) at least one integrated circuit or semiconductor die.

The processor includes a front-end unit 212. The front-end unit broadly represents a first portion of the processor that obtains instructions 211 (e.g., from system memory) and decodes the instructions. The instructions may represent macroinstructions, machine code instructions, or other instructions of an instruction set of the processor. The instructions may include a wide variety of types of instructions generally included in the instruction sets of processors, such as, for example, data processing instructions (e.g., arithmetic instructions, logical instructions, cryptographic instructions, etc.), memory access instructions (e.g., load instructions, store instructions, gather instructions, etc.), control flow transfer instructions (e.g., indirect branch or jump instructions, conditional branch or jump instructions, etc.).

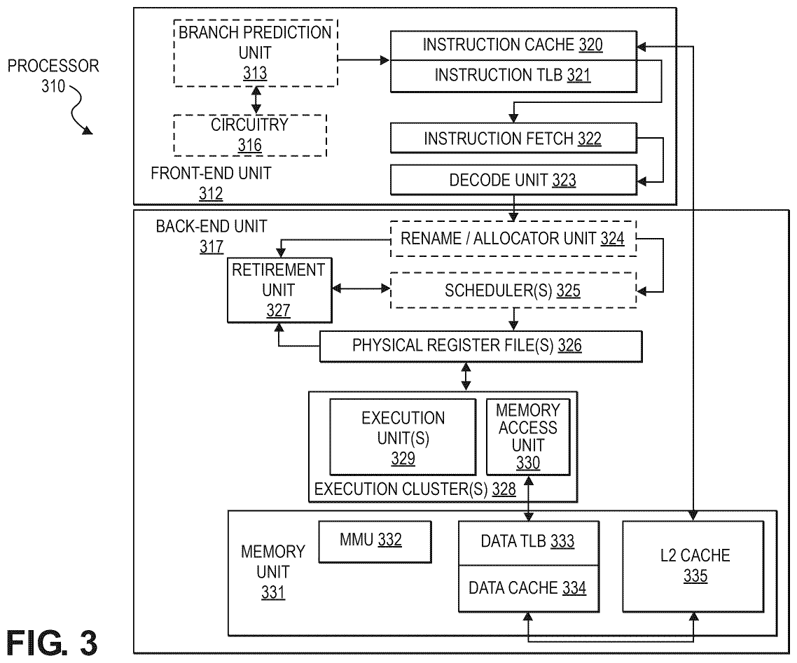

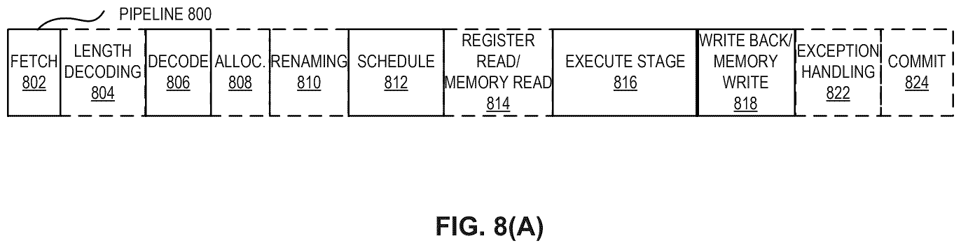

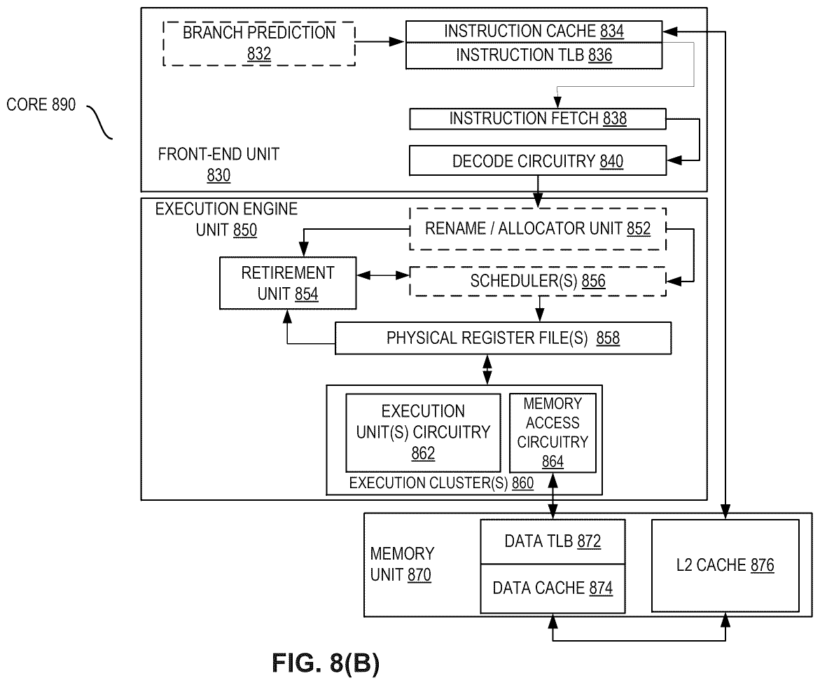

The front-end unit may include various types of units or circuits to determine program control flow, locate and obtain the instructions, and decode the instructions. The types of units in the front-end unit may vary from one architecture and/or processor design to another and the scope of the invention is not limited to any combination of units. Commonly, the front-end unit may include prediction logic (e.g., a branch prediction unit to make predictions for branch instructions), one or more instruction caches to cache or store instructions, one or more instruction translation lookaside buffers (TLBs) to cache or store translations of addresses of instructions, an instruction fetch unit to fetch instructions, and an instruction decode unit to decode the instructions. One specific example of a suitable front-end unit includes the front-end unit 312 shown in FIG. 3, although the scope of the invention is not so limited. Another specific example of a suitable front-end unit includes the front-end unit 830 shown in FIG. 8(B), although the scope of the invention is not so limited.

The processor includes a back-end unit 217 coupled with the front-end unit 212. The back-end unit broadly represents a second portion of the processor to execute and commit the instructions. The back-end unit may include various types of units or circuits to execute and commit the instructions, such as, for example, a unit to dispatch or schedule the instructions for execution, a variety of different types of execution units to execute the various instructions, a unit to retire or commit the instructions, etc. The types of units in the back-end unit may vary from one architecture and/or processor design to another and the scope of the invention is not limited to any combination of units. In some embodiments, the back-end unit may be in-order. In other embodiments, the back-end unit may be out-of-order and the back-end unit may include one or more units to reorder instructions for out-of-order execution and in-order retirement (e.g., scheduler unit, a reorder buffer, etc.). Examples of different types of execution units for the back-end unit include, but are not limited to, arithmetic units, logic units, arithmetic logic units (ALUs), cryptographic units, scalar execution units, vector execution units, matrix units, branch or jump units, memory access units (e.g., load units, store units, load-store units, gather units), and the like, and various combinations thereof. One specific example of a suitable back-end unit includes the back-end unit 317 shown in FIG. 3, although the scope of the invention is not so limited. Another specific example of a suitable back-end unit includes the execution engine unit 850 shown in FIG. 8(B), although the scope of the invention is not so limited.

Referring again to FIG. 2A, the front-end unit includes a prediction unit 213. The prediction unit includes storage 214 to store prediction state 215. The prediction state broadly represents history or other information learned from prior operation of the processor (e.g., branch history, prior execution history, etc.) that may be used to make predictions about future operation of the processor (e.g., indirect branch predictions, predictions of branch directions, etc.). The prediction unit may make predictions associated with some of the instructions based on the prediction state. In some embodiments, the prediction unit may be a branch prediction unit to make predictions about branch instructions or jump instructions. Examples of suitable branch prediction units include, but are not limited to, conditional branch predictors to predict branch directions, indirect branch predictors, and branch target buffers (BTBs).

In other embodiments, the prediction unit may be a memory renaming prediction unit. Memory renaming is a way to predict where load data from memory may already exist in an active physical register from a recent store to that same address and use that physical register for the consumer of the load immediately without waiting for the load instruction to get sent to the memory execution unit. This prediction involves detecting cases of a store to a given address followed by a later load of that address into a logical register or as the source to a logical operation in the execution units. This detection may be done in a Memory Execution Unit that monitors active stores and loads and has the full address information and may mark store/load pairs and store them in a table/array. During fetch, decode or allocation stages of a processor this memory renaming prediction table may be checked to see if a current load/store instruction matches the tag of something that the Memory Execution Unit had marked before. If a load store combination is detected at allocation time, then the user of the load data (e.g., either move to logical register or source of arithmetic unit operation) may directly use the register that was loaded with the store's data under the assumption that it matches with the load's request. Then, operations in the execution units may immediately use the physical register and if that prediction was incorrect (e.g., as determined with the memory execution unit checks to make sure the data and/or address correctly matched the prediction), then any of the subsequent operations that followed the load (speculatively executed instructions with the bad speculative data) may be discarded (e.g., cleared, nuked, invalidated, etc.) and the corrected data should be used to complete those operations.

In some embodiments, the front-end unit may include circuitry 216 to serially or sequentially clear a plurality of subsets of the prediction state. In some embodiments, this may be done upon switching to a new code, context, or mode and/or in response to a switch from one code, context, or mode to another to help protect against side-channel security vulnerabilities and/or to help reduce the risk of leaking prediction state to a different code, context, or mode. In other embodiments, this may be done at various other times, such as, for example, to initialize the prediction state upon a cold reset or boot, a warm reset or boot, when resuming execution from a C6 sleep state or other light sleep state, or to change or otherwise clean prediction state during debugging or other testing.

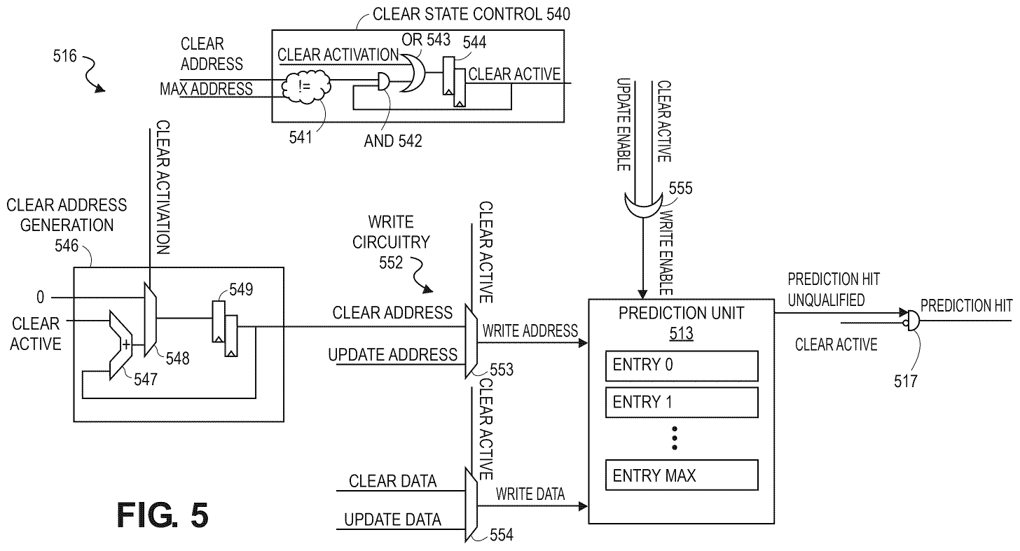

In some embodiments, the plurality of the subsets of the prediction state may be a plurality of distinct, individual, discrete, or otherwise sequentially indexed entries of an array or table of prediction state. In other embodiments, the plurality of the subsets of the prediction state may include a plurality of distinct, individual, or discrete portions of prediction information stored or held in flip flops or other circuitry. For example, this may be the case for stew-based calculation information which is held active in the flip flops but not really stored in an array or table. In still other embodiments, the plurality of the subsets of the prediction state may include a plurality of distinct, individual, or discrete portions of least recently used and/or most recently used information and/or round robin information used to select structures for replacement (e.g., select which way of a set associative array would get replaced on a new allocation). Such information may be stored in an array or table, held in flip flops or other circuitry, or held or stored within the processor. It is not required to clear all the subsets (e.g., all the entries in an array or table) but rather in some cases this may be selectively done for only some of the subsets (e.g., only those entries in an array or table having a certain application space identifier (ASID), a certain virtual machine identifier (VMID), marked as having a certain privilege level (e.g., user, supervisor, guest, host, trusted execution environment, non-trusted execution environment, in some cases a different thread identifier, etc.). Advantageously, serially or sequentially clearing the plurality of subsets of the prediction state may help to reduce or limit the amount of additional circuitry or other hardware needed to clear the prediction state, which in turn may help to reduce chip size, power consumption, and design complexity. For example, when initializing entries of an array or table one at a time, existing circuitry or hardware that is used to write the entries may optionally be re-used to write an initialization value or other value over the entries so that only a relatively small amount of additional logic may need to be added (e.g., the clear address generation circuitry 546 and control state control circuitry 540 of FIG. 5). In some cases, multiple subsets of prediction state may be cleared concurrently. For example, in some cases (e.g., when the amount of prediction state is relatively large), the prediction state may optionally include multiple parallel arrays or tables of prediction state each having a respective write port. In such cases, an entry in each of the arrays or tables may optionally be cleared concurrently and then this process may be repeated to sequentially clear additional entries in each of the arrays or tables.

An alternative possible approach is to add a relatively large amount of additional circuitry or hardware to allow all the prediction state to be flash invalidated in a single clock cycle. For example, a new dedicated valid bit may be included for each entry of an array or table of prediction state and additional circuitry or hardware may be included to simultaneously flash invalidate all the new dedicated valid bits in a single clock cycle. However, the arrays or tables are in some cases very large and the extra storage needed for the new dedicated valid bits may be significant. Also, a significant amount of additional circuitry or hardware may be needed to flash clear the new valid bits all at once and to read the new valid bits to determine whether each entry has a hit at read time. As a result, this alternate possible approach tends to increase chip size, power consumption, and design complexity.

The subsets of the prediction state may be cleared in various ways in different embodiments. In some embodiments, clearing the subsets of the prediction state may optionally include changing them or otherwise causing them to have an initialized state. The initialized state may represent a default or empty state and/or may represent the state caused to be stored in the storage upon resuming from one or more of a reset, boot, or light sleep state. In other embodiments, clearing the subsets of the prediction state may optionally include changing them or otherwise causing them to have a same value, a fixed or predetermined value, a non-secret or non-confidential value, a random or pseudo-random value, a meaningless or nonsense value, or another value that is different than and does not easily reveal the prediction state. As one specific example, the subsets of the prediction state may optionally be overwritten with a value where all bits are cleared to binary zero (e.g., 0000000000 . . . ) or a value where all bits are set to binary one (e.g., 1111111111 . . . ). In still other embodiments, clearing the subsets of the prediction state may optionally include scrambling, compromising, obscuring, obfuscating, or otherwise clearing the prediction state. As one specific example, the subsets of the prediction state may optionally be exclusive-OR'd or otherwise logically combined with one or more secret values, two or more subsets of the prediction state may logically combined, etc. Note that it is not required that all bits of the prediction state be changed if enough bits are changed that the prediction state is not easily revealed. These are just a few illustrative examples. Those skilled in the art, and having the benefit of the present disclosure, will appreciate that there are still other ways of clearing the subsets of the prediction state.

Depending upon the amount of the prediction state and the size of the subsets, the clearing of the prediction state may take some time. As shown at 218, in some embodiments, the processor (e.g., at least a portion of the processor) may continue to process the instructions, while the plurality of the subsets of the prediction state are being cleared. In some embodiments, at least some, or most, or substantially all the front-end unit (e.g., optionally except for the prediction unit 213) may continue to process the instructions for execution and/or make forward progress (e.g., obtain instructions from memory, fetch instructions, decode instructions, etc.), while the plurality of the subsets of the prediction state are being cleared. Likewise, in some embodiments, at least some, or most, or substantially all the back-end unit may continue to execute or otherwise process the instructions and/or make forward progress (e.g., dispatching or scheduling instructions, executing instructions, retiring instructions, etc.), while the plurality of the subsets of the prediction state are being cleared. Accordingly, even though clearing the subsets of prediction state may take some time, at least some of the front-end unit and at least some of the back-end unit may continue to operate and perform useful work during this time. Advantageously, this may help to improve performance as compared to if the entire front-end unit and/or the entire processor was entirely stopped while the subsets of prediction state were cleared.

An alternate possible approach to clear the prediction state is to invoke a microcode handler to run a microcode controlled initialization flow to initialize the prediction state. This approach involves entirely stopping the processing of the instructions 211 in the front-end unit and the back-end unit and entering a special mode of the processor. While in this special mode the microcode controlled initialization flow may run commands (e.g., microcode) to initialize the prediction state. It generally tends to take a significant amount of time to enter this special mode and to exit this special mode to resume normal execution. This may be due in part to checks that need to be performed, the need to poll and wait for certain things to occur before entering the special mode, etc. One significant drawback with this approach is that the processing of the instructions is entirely stopped (e.g., the processor may operate to execute the microcode commands but may not fetch the instructions 211, decode the instructions 211, execute the instructions 211, etc.). As a result, this alternate possible approach tends to significantly reduce performance.

FIG. 2B is a block diagram of a first example embodiment of branch history table 296. The branch history table stores branch prediction state. The branch history table includes a plurality of entries 298-0 through 298-N, where N may be any suitable number often on the order of hundreds to many thousands. Each entry stores a different subset of the prediction state. Specifically, each entry stores a program counter (PC) of a branch instruction, a target program counter (target PC) of a target of the branch instruction, and a prediction of whether the branch is taken or not taken (e.g., 1 for taken or 0 for not taken). In some embodiments, clearing different subsets of prediction state may include clearing the prediction state from all of the entries 298-0 through 298-N.

FIG. 2C is a block diagram of a second example embodiment of branch history table 297. The branch history table stores branch prediction state. The branch history table includes a plurality of entries 299-0 through 299-N, where N may be any suitable number often on the order of hundreds to many thousands. Each entry stores a different subset of the prediction state. Specifically, each entry stores a program counter (PC) of a branch instruction, a target program counter (target PC) of a target of the branch instruction, a prediction of whether the branch is taken or not taken (e.g., 1 for taken or 0 for not taken), and an identifier. In various embodiments, the identifier may be an application space identifier (ASID), a virtual machine identifier (VMID), a user or supervisor indicator (U/S), or another identifier of a context or mode as described elsewhere herein. In some embodiments, clearing different subsets of prediction state may optionally include clearing the prediction state from all of the entries 299-0 through 299-N. In other embodiments, clearing different subsets of prediction state may optionally include clearing the prediction state in all entries for a given identifier without clearing the prediction state in entries for a different identifier. For example, the entries 299-0 and 299-2 corresponding to the identifier ID1 may be cleared without clearing the entries 299-1 and 299-N corresponding to the identifier ID2.

FIG. 3 is a block diagram of a detailed example embodiment of a processor 310 having a detailed example embodiment of a front-end unit 312 and a detailed example embodiment of a back-end unit 317. The processor 210 may be the same as, like, or different than the processor 210 of FIG. 2A. To avoid obscuring the description, the different and/or additional aspects of the embodiment of FIG. 3 will primarily be described, without repeating all the aspects that may optionally be the same or like those already described for the embodiment of FIG. 2A.

The front-end unit includes a branch prediction unit 313 to make predictions associated with branch instructions. The branch prediction unit may include a conditional branch predictor to predict branch directions, an indirect branch predictor, and a branch target buffer (BTB), or a combination thereof. In some embodiments, the circuitry 316 is included to sequentially clear a plurality of subsets of prediction state of the prediction unit as described elsewhere herein (e.g., sequentially clear all entries of an array of table of branch prediction state, or sequentially clear all entries of an array or table of branch prediction state associated with a certain identifier (e.g., an ASID, a VMID, other context or mode identifier, etc.)). An instruction cache 320 (e.g., a level one (L1) instruction cache) is coupled with the branch prediction unit. The instruction cache may be used to cache or store instructions. An instruction TLB 321 (e.g., a level one (L1) instruction TLB) is coupled with the branch prediction unit. The instruction TLB may cache or store translations of addresses of pages or other sets of instructions. An instruction fetch unit 322 is coupled with the instruction cache and the instruction TLB. The instruction fetch unit may fetch instructions (e.g., from the instruction cache). A decode unit 323 is coupled with the instruction fetch unit. The decode unit may decode the fetched instructions into lower-level control signals, operations, or decoded instructions (e.g., micro-instructions, micro-operations, micro-code entry points, etc.). The decode unit may be implemented using various approaches including, but not limited to, microcode read only memories (ROMs), look-up tables, hardware implementations, programmable logic arrays (PLAs), and combinations thereof.

The back-end unit includes a rename/allocator unit 324 coupled with the decode unit to receive the decoded instructions. One or more scheduler units 325 are coupled with the rename/allocator unit. The one or more scheduler units may include any of various schedulers, including reservations stations, central instruction window, etc. One or more physical register files 326 are coupled with the one or more scheduler units and a retirement unit 327. The retirement unit is also coupled with the rename/allocator unit and the one or more scheduler units. There are various possible ways that register renaming and out-of-order execution may be implemented, such as, for example, using a reorder buffer and a retirement register file, a future file, a history buffer, a retirement register file, a register map and a pool of registers, or a combination thereof. One or more execution clusters 328 are coupled with the one or more physical register files. The one or more execution clusters include one or more execution units 329 to execute instructions. The types of execution units described previously are suitable. The one or more execution clusters also include at least one memory access unit 330 (e.g., a load unit, a store unit, a load-store unit) to perform memory access operations (e.g., loads, stores, etc.). A memory unit 331 is coupled with the memory access unit. The memory unit includes a memory management unit 332 to perform page table walks to translate virtual addresses to corresponding physical addresses. The memory unit also includes a data TLB 333 (e.g., a level one (L1) data TLB) to cache or store address translations for data and a data cache 334 (e.g., a level one (L1) data cache) to cache or store data to be processed by the processor. A level two (L2) cache 335 is coupled with the instruction cache 320 and the data cache 334. The L2 cache may cache or store instructions and data. The L2 cache may be coupled with zero or more other levels of cache and eventually to system memory.

As previously mentioned, in some embodiments, at least some, or most, or substantially all the front-end unit 312 (e.g., optionally except for the branch prediction unit 313) may continue to process instructions for execution and/or make forward progress, while the plurality of the subsets of the prediction state are being cleared. Likewise, in some embodiments, at least some, or most, or substantially all the back-end unit 317 may continue to process these instructions and/or make forward progress, while the plurality of the subsets of the prediction state are being cleared. For example, in some embodiments, the instruction fetch unit 322 may fetch additional instructions, the instruction decode unit 323 may decode these additional fetched instructions, and the execution units 329 and/or the execution clusters 328 may perform operations corresponding to these additional instructions, while the plurality of the subsets of the prediction state are being cleared. As another example, in some embodiments, the instruction cache 320 may issue a cache fill request for a cacheline of additional instructions and the processing or servicing of the cache fill request may progress and potentially complete, while the subsets of prediction state are being cleared. As yet another example, in some embodiments, a miss for a translation for a virtual address of a page or other set of instructions may be detected in the instruction TLB 321 and in response to the miss and/or based on the miss the MMU 332 may initiate a page table walk to translate the virtual address to a corresponding physical address, the MMU may work on or progress through the page table walk, and in some cases the MMU may potentially complete the page table walk and store a translation of the virtual address to the physical address in the instruction TLB 321, while the subsets of prediction state are being cleared.

In situations where the clearing of the subsets of the prediction state is performed due to a context or mode switch, it is likely that the instruction cache will need to be populated with instructions for the new context or mode, that page table walks will need to be performed to determine address translations for the addresses of new pages or other sets of instructions, and the like. Performing the cache fill requests and the page table walks generally tend to take a relatively large amount of time to complete. These relatively time consuming operations may begin and progress while the plurality of the subsets of the prediction state are being cleared. Accordingly, even though clearing the subsets of prediction state may take some time, at least some of the front-end unit and/or at least some of the back-end unit may continue to operate and perform useful work during this time. Advantageously, this may help to improve performance as compared to if the entire front-end unit and/or the entire processor was entirely stopped while the subsets of prediction state were cleared.

FIG. 4 is a block diagram of an embodiment of a front-end unit 412 having a prediction unit 413, a first circuitry 416 to sequentially clear a plurality of subsets of prediction state 415, and a second circuitry 417 to control how the prediction unit 413 makes predictions while the subsets of the prediction state 415 are being cleared. The prediction unit has storage 414 to store the prediction state. The front-end unit, the prediction unit, the storage, and the prediction state, may optionally be the same as, like, or different than, those already described above for FIGS. 2-3. To avoid obscuring the description, the different and/or additional aspects of the embodiment of FIG. 4 will primarily be described, without repeating all the aspects that may optionally be the same or like those already described for the embodiment of FIGS. 2-3.

In the illustrated embodiment, the front-end unit also optionally includes the second circuitry 417 to control how the prediction unit 413 makes predictions while the subsets of the prediction state 415 are being cleared. In some embodiments, the second circuitry may be operative to force the prediction unit to make predictions that are inconsistent with the prediction state, while the plurality of the subsets of the prediction state are being sequentially cleared. In some embodiments, the second circuitry may be operative to prevent the prediction unit from making the predictions using, according to, consistent with, influenced by, or otherwise based on the prediction state, while the plurality of the subsets of the prediction state are being sequentially cleared. The predictor may continue to operate but may not make predictions that are based on the prediction state. In some embodiments, this may optionally be done selectively for the only as-of-yet uncleared subsets of the prediction state. This may potentially help to improve performance by allowing some predictions to be made sooner. In other embodiments, this may optionally be done for all the subsets of the prediction state whether or not they have already been cleared until the process of clearing all of the subsets has completed. This may tend to offer a less complex implementation.

Controlling how the prediction unit makes predictions may be done in different ways in different embodiments and/or for different types of prediction units. In some embodiments, the prediction unit may be a bimodal predictor or otherwise of a type that does not make predictions based on tag matches, and in some such embodiments the second circuitry, in order to prevent the prediction unit from making the predictions based on the prediction state, may force the prediction unit to make predictions consistent with the prediction state being equal to an initialization state while the plurality of the subsets of the prediction state are being sequentially cleared. The initialized state may represent a default or empty state and/or may represent the state caused to be stored in the storage upon resuming from one or more of a reset, boot, or light sleep state. Alternatively, instead of the initialization state, the prediction unit may be forced to make predictions consistent with the prediction state being equal to something other than the prediction state such as being equal to a fixed state, a random state, an obfuscated state, etc. Side channel attacks should generally be avoided if the predictions are not made according to the prediction state.

In other embodiments, the prediction unit may be an indirect branch predictor or otherwise of a type that makes predictions associated with the instructions when and/or based on tag matches (e.g., requires a tag match to make a prediction), and in some such embodiments the second circuitry, in order to prevent the prediction unit from making the predictions based on the prediction state, may force the prediction unit to determine that there are no tag matches and/or force the prediction unit to make predictions as if no tag matches are detected, while the plurality of the subsets of the prediction state are being sequentially cleared. This may be done in different ways, such as, for example, by forcing the predictor to ignore any tag hits, forcing the prediction unit to predict according to an initialization state for which there would be no tag hits, forcing the prediction unit to predict according to some other state other than the prediction state such as a fixed state, a random state, an obfuscated state, etc.

Advantageously, this may help to provide additional protection against side-channel security vulnerabilities and/or help further reduce the risk of revealing prediction state. For example, this may help to prevent code executing in a new context or mode from secing the prediction state of code executing in a prior context or mode (e.g., what happened in the code in the prior context or mode) and/or may help to prevent code executing in the prior context or mode from influencing branch predictions and therefore control flow for code executing in the new context or mode. After all subsets of the prediction state needing to be cleared have been cleared the prediction unit may begin to make predictions again and may begin to accumulate new prediction state (e.g., for the new context or mode).

FIG. 5 is a circuit diagram of a detailed example embodiment of circuitry 516 to sequentially clear a plurality of subsets of prediction state of a prediction unit 513 and circuitry 517 to control how the prediction unit makes predictions while the subsets of the prediction state are being cleared. In the illustrated example, the plurality of the subsets are different entries from entry 0 to entry max of the prediction unit 513. Initially, when it is time to clear subsets of prediction state (e.g., on context switches, mode switches, upon initialization, upon a cold or warm boot, etc.) the processor (e.g., microcode) may assert a “clear activation” signal to control the circuitry 516 to start clearing subsets of prediction state. By way of example, the clear activation may represent a change in a value of a bit in a control and/or status register, a pulse signal asserted high for one clock cycle, or the like.

The clear activation signal may be provided or input to a clear address generation circuitry 546 to control the clear address generation circuitry to start generating addresses of subsets of prediction state to be cleared. The clear activation signal is provided as a control to a multiplexer or other selection circuitry 548. The multiplexer or other selection circuitry 548 may receive a starting address which in the illustrated example is zero (0) and an output of an adder, incrementor, or other address update circuitry 547. The assertion of the clear activation signal may cause the starting address which in the illustrated example is zero (0) to be selected as the starting clear address. This starting clear address of zero (0) may be output to a flip flop 549. The flip flop 549 may stop the clear address output from the clear address generation circuitry and hold it until the rise of the next clock cycle at which point the clear address may be provided to a multiplexer or other selection circuitry 553 of write circuitry 552 as well as being provided as an input to the adder, incrementor, or other address update circuitry 547. Another input to the adder, incremented, or other address update circuitry 547 is a “clear active” signal which is asserted on each clock cycle while subsets of prediction state are being cleared. The adder, incrementor, or other address update circuitry 547 may increment, add one to, or otherwise update the input clear address on each cycle when the clear active signal is provided as an input. When the clear activation signal is not asserted the selection circuitry 548 may select the incremented or otherwise updated clear address for output to the flip flop 549. This may be repeated over multiple clock cycles until all subsets of the prediction state (or at least all that are to be cleared) have been addressed. By way of example, on the first clock cycle a clear address of zero (0) may be output from the clear address generation circuitry 546, on a second clock cycle a clear address of one (1) may be output, on a third clock cycle a clear address of two (2) may be output, and so forth. This is just one example of suitable clear address generation circuitry. It is also possible to start with a maximum address and decrement, or to otherwise step or proceed through the plurality of the subsets of prediction state.

The clear activation signal, the clear address output from the clear address generation circuitry 546, and a maximum address (MAX Address) may be input to a clear state control circuitry 540. The maximum address (MAX Address) may represent the address of the entry max or otherwise represent the maximum addressed subset of the prediction state. Once the clear activation signal has been asserted, the clear state control circuitry 540 may output a clear active signal at a logical high signal level (e.g., a bit set to binary one) as long as the clear address is not equal to the maximum address (MAX Address), and then when the clear address is equal to the maximum address (MAX Address) may output a clear active signal at a logical low signal level (e.g., a bit cleared to binary zero). In the specific illustrated clear state control circuitry 540, the clear address from the clear address generation circuitry 546 may be provided or input to comparison circuitry 541. The maximum address (MAX Address) may also be provided or input to the comparison circuitry 541. In the illustrated example, the comparison circuitry 541 is not equal (!=) type comparison circuitry that may determine whether the clear address is not equal (!=) to the maximum address. The comparison circuitry 541 may output a logical high signal (e.g., a bit set to binary one) when the clear address is not equal to the maximum address or otherwise the comparison circuitry 541 may output a logical low signal (e.g., a bit cleared to binary zero). A logical AND gate 542 may receive the logical high or logical low signal output from the comparison circuitry 541. The logical AND gate 542 may also receive a logical high or low signal returned from a flip flop 544. The logical AND gate 542 may output a logical high signal (e.g., a bit set to binary one) when both of its inputs are logical high signals or otherwise the logical AND gate 542 may output a logical low signal (e.g., a bit cleared to binary zero). A logical OR gate 543 may receive the output logical high or logical low signal from the logical AND gate 542. The logical OR gate 543 may also receive as an input the clear activation signal. The logical OR gate 543 may output a logical high signal (e.g., a bit set to binary one) when either of its puts are logical high signals or otherwise the logical OR gate 543 may output a logical low signal (e.g., a bit cleared to binary zero). The logical high or low signal output of the logical OR gate 543 may output to a flip flop 544. The flip flop. 544 may stop the logical high or low signal output of the logical OR gate 543 and hold it until the rise of the next clock cycle and then output it as the clear active signal. The clear active being logical high may indicate that the circuitry 516 is active or enabled to clear subsets of prediction state (e.g., increment clear addresses, etc.). The clear active being logical low may represent the circuitry 516 being inactive or disabled.

The clear active signal may be provided or input to write circuitry 552. As shown, the clear active signal may be provided as a control of a first multiplexer or other selection circuitry 553 and may be provided as a control of a second multiplexer or other selection circuitry 554. When the clear active signal is at a logical high level the first multiplexer or other selection circuitry 553 may select a clear address provided at a first input as a write address to write the prediction unit 513. Alternatively, when the clear active signal is at a logical low level the first multiplexer or other selection circuitry 553 may select an update address provided at a second input as the write address to write the prediction unit 513. Similarly, when the clear active signal is at a logical high level the second multiplexer or other selection circuitry 554 may select a clear data provided at a first input as a write data to be written to the prediction unit 513 at the selected write address. The clear data may represent initialization data, all zeroes, all ones, or other values suitable for clearing prediction state as discussed elsewhere herein. Alternatively, when the clear active signal is at a logical low level the second multiplexer or other selection circuitry 553 may select an update address provided at a second input as the write address to write the prediction unit 513. The update address and update data may conform to conventional use of the prediction unit. The clear active and an update enable may also be provided as inputs to a logical OR gate 555. When either the clear active or the update enable are at a logical high level the OR gate 555 may output a write enable signal to enable writing to the prediction unit 513. By way of example, once the clear activation signal has been asserted, the clear active circuit may be logic high to enable the circuitry 516 to clear all entries entry 0 through entry max and the clear address may be incremented from zero (0) through MAX Address. Then, the conventional use of the prediction unit may be re-enabled, and the prediction unit may be trained and used for predictions.

Also included is the circuitry 517 to control how the prediction unit makes predictions while the subsets of the prediction state are being cleared. The circuitry 517 receives a “prediction hit unqualified” signal as a first input and the “clear active” signal as a second input. The prediction hit unqualified may represent the actual output of the prediction unit based on the prediction state (e.g., the content of the entries). The prediction hit unqualified signal is internal and is not exposed to prediction consuming circuitry or logic other than via the intervening circuitry 517. When no clearing of the prediction state is underway, the circuitry allows the prediction hit unqualified signal to be passed through as a prediction hit signal. This represents normal use of the prediction unit when no clearing is underway. Conversely, while the prediction state is being cleared (e.g., the clear active signal is at a logical high level), the circuitry 517 may prevent the prediction hit unqualified signal from being passed through as the prediction hit signal. The circuitry 517 may be implemented in various different ways. In the illustrated example, the circuitry includes an AND gate and a NOT of the clear active signal input to the AND gate. When clear active is at a logical high level the NOT makes the clear active have a logical low level to force the prediction hit signal output from the AND gate to have a logical low level. This prevents any prediction based on the prediction state from passing through the AND gate and being delivered to prediction consuming circuitry or logic. Forcing the prediction hit signal to zero is well suited for some types of prediction units (e.g., prediction units that make predictions based on a tagged “hit”), since it forces the prediction hit signal to be the equivalent of having no prediction (e.g., there were no hits on any of the entries). For other types of prediction units (e.g., prediction units that don't necessarily require a tagged “hit” but just always use a taken not taken value from a vector for any conditional branch encountered), predetermined prediction state (e.g., all zeroes, all ones, etc.) may optionally be multiplexed through to be the output prediction hit (e.g., to force all conditional branches to look not taken or taken but not a mixture based on the actual prediction state).

### Example Computer Architectures

Detailed below are descriptions of example computer architectures. Other system designs and configurations known in the arts for laptop, desktop, and handheld personal computers (PC) s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are suitable.

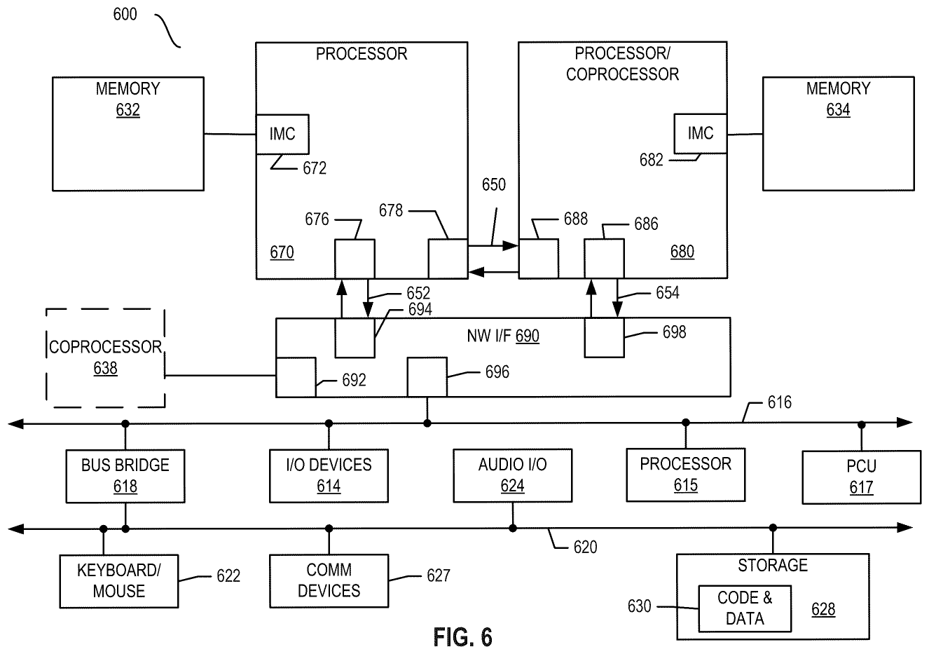

FIG. 6 illustrates an example computing system. Multiprocessor system 600 is an interfaced system and includes a plurality of processors or cores including a first processor 670 and a second processor 680 coupled via an interface 650 such as a point-to-point (P-P) interconnect, a fabric, and/or bus. In some examples, the first processor 670 and the second processor 680 are homogeneous. In some examples, the first processor 670 and the second processor 680 are heterogenous. Though the example system 600 is shown to have two processors, the system may have three or more processors, or may be a single processor system. In some examples, the computing system is a system on a chip (SoC).

Processors 670 and 680 are shown including integrated memory controller (IMC) circuitry 672 and 682, respectively. Processor 670 also includes interface circuits 676 and 678; similarly, second processor 680 includes interface circuits 686 and 688. Processors 670, 680 may exchange information via the interface 650 using interface circuits 678, 688. IMCs 672 and 682 couple the processors 670, 680 to respective memories, namely a memory 632 and a memory 634, which may be portions of main memory locally attached to the respective processors.

Processors 670, 680 may each exchange information with a network interface (NW I/F) 690 via individual interfaces 652, 654 using interface circuits 676, 694, 686, 698. The network interface 690 (e.g., one or more of an interconnect, bus, and/or fabric, and in some examples is a chipset) may optionally exchange information with a coprocessor 638 via an interface circuit 692. In some examples, the coprocessor 638 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 670, 680 or outside of both processors, yet connected with the processors via an interface such as P-P interconnect, such that either or both processors' local cache information may be stored in the shared cache if a processor is placed into a low power mode.

Network interface 690 may be coupled to a first interface 616 via interface circuit 696. In some examples, the first interface 616 may be an interface such as a Peripheral Component Interconnect (PCI) interconnect, a PCI Express interconnect or another I/O interconnect. In some examples, the first interface 616 is coupled to a power control unit (PCU) 617, which may include circuitry, software, and/or firmware to perform power management operations regarding the processors 670, 680 and/or co-processor 638. PCU 617 provides control information to a voltage regulator (not shown) to cause the voltage regulator to generate the appropriate regulated voltage. PCU 617 also provides control information to control the operating voltage generated. In various examples, PCU 617 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 617 is illustrated as being present as logic separate from the processor 670 and/or processor 680. In other cases, PCU 617 may execute on a given one or more of cores (not shown) of processor 670 or 680. In some cases, PCU 617 may be implemented as a microcontroller (dedicated or general-purpose) or other control logic configured to execute its own dedicated power management code, sometimes referred to as P-code. In yet other examples, power management operations to be performed by PCU 617 may be implemented externally to a processor, such as by way of a separate power management integrated circuit (PMIC) or another component external to the processor. In yet other examples, power management operations to be performed by PCU 617 may be implemented within BIOS or other system software.

Various I/O devices 614 may be coupled to first interface 616, along with a bus bridge 618 which couples first interface 616 to a second interface 620. In some examples, one or more additional processor(s) 615, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 616. In some examples, the second interface 620 may be a low pin count (LPC) interface. Various devices may be coupled to second interface 620 including, for example, a keyboard and/or mouse 622, communication devices 627 and storage circuitry 628. Storage circuitry 628 may be one or more non-transitory machine-readable storage media as described below, such as a disk drive or other mass storage device which may include instructions/code and data 630 and may implement the storage 'ISAB03 in some examples. Further, an audio I/O 624 may be coupled to second interface 620. Note that other architectures than the point-to-point architecture described above are possible. For example, instead of the point-to-point architecture, a system such as multiprocessor system 600 may implement a multi-drop interface or other such architecture.

### Example Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

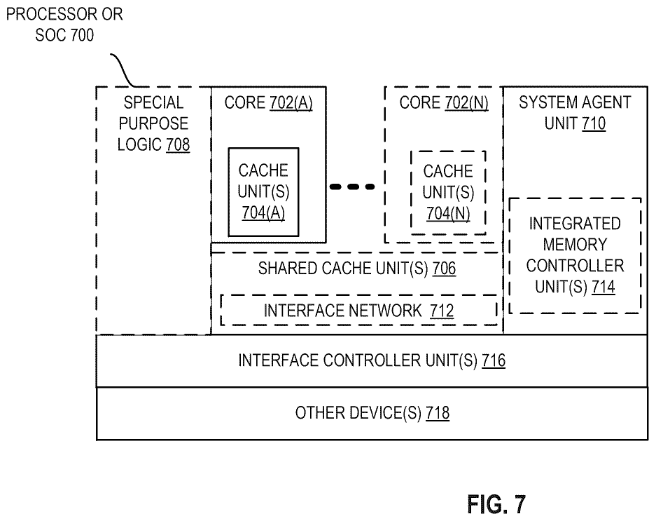

FIG. 7 illustrates a block diagram of an example processor and/or SoC 700 that may have one or more cores and an integrated memory controller. The solid lined boxes illustrate a processor 700 with a single core 702(A), system agent unit circuitry 710, and a set of one or more interface controller unit(s) circuitry 716, while the optional addition of the dashed lined boxes illustrates an alternative processor 700 with multiple cores 702(A)-(N), a set of one or more integrated memory controller unit(s) circuitry 714 in the system agent unit circuitry 710, and special purpose logic 708, as well as a set of one or more interface controller units circuitry 716. Note that the processor 700 may be one of the processors 670 or 680, or co-processor 638 or 615 of FIG. 6.

Thus, different implementations of the processor 700 may include: 1) a CPU with the special purpose logic 708 being integrated graphics and/or scientific (throughput) logic (which may include one or more cores, not shown), and the cores 702(A)-(N) being one or more general purpose cores (e.g., general purpose in-order cores, general purpose out-of-order cores, or a combination of the two); 2) a coprocessor with the cores 702(A)-(N) being a large number of special purpose cores intended primarily for graphics and/or scientific (throughput); and 3) a coprocessor with the cores 702(A)-(N) being a large number of general purpose in-order cores. Thus, the processor 700 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 700 may be a part of and/or may be implemented on one or more substrates using any of several process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 704(A)-(N) within the cores 702(A)-(N), a set of one or more shared cache unit(s) circuitry 706, and external memory (not shown) coupled to the set of integrated memory controller unit(s) circuitry 714. The set of one or more shared cache unit(s) circuitry 706 may include one or more mid-level caches, such as level 2 (L2), level 3 (L3), level 4 (L4), or other levels of cache, such as a last level cache (LLC), and/or combinations thereof. While in some examples interface network circuitry 712 (e.g., a ring interconnect) interfaces the special purpose logic 708 (e.g., integrated graphics logic), the set of shared cache unit(s) circuitry 706, and the system agent unit circuitry 710, alternative examples use any number of well-known techniques for interfacing such units. In some examples, coherency is maintained between one or more of the shared cache unit(s) circuitry 706 and cores 702(A)-(N). In some examples, interface controller units circuitry 716 couple the cores 702 to one or more other devices 718 such as one or more I/O devices, storage, one or more communication devices (e.g., wireless networking, wired networking, etc.), etc.

In some examples, one or more of the cores 702(A)-(N) are capable of multi-threading. The system agent unit circuitry 710 includes those components coordinating and operating cores 702(A)-(N). The system agent unit circuitry 710 may include, for example, power control unit (PCU) circuitry and/or display unit circuitry (not shown). The PCU may be or may include logic and components needed for regulating the power state of the cores 702(A)-(N) and/or the special purpose logic 708 (e.g., integrated graphics logic). The display unit circuitry is for driving one or more externally connected displays.

The cores 702(A)-(N) may be homogenous in terms of instruction set architecture (ISA). Alternatively, the cores 702(A)-(N) may be heterogeneous in terms of ISA; that is, a subset of the cores 702(A)-(N) may be capable of executing an ISA, while other cores may be capable of executing only a subset of that ISA or another ISA.

### Example Core Architectures-In-Order and Out-of-Order Core Block Diagram

FIG. 8(A) is a block diagram illustrating both an example in-order pipeline and an example register renaming, out-of-order issue/execution pipeline according to examples. FIG. 8(B) is a block diagram illustrating both an example in-order architecture core and an example register renaming, out-of-order issue/execution architecture core to be included in a processor according to examples. The solid lined boxes in FIGS. 8(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 8(A), a processor pipeline 800 includes a fetch stage 802, an optional length decoding stage 804, a decode stage 806, an optional allocation (Alloc) stage 808, an optional renaming stage 810, a schedule (also known as a dispatch or issue) stage 812, an optional register read/memory read stage 814, an execute stage 816, a write back/memory write stage 818, an optional exception handling stage 822, and an optional commit stage 824. One or more operations can be performed in each of these processor pipeline stages. For example, during the fetch stage 802, one or more instructions are fetched from instruction memory, and during the decode stage 806, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 806 and the register read/memory read stage 814 may be combined into one pipeline stage. In one example, during the execute stage 816, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 8(B) may implement the pipeline 800 as follows: 1) the instruction fetch circuitry 838 performs the fetch and length decoding stages 802 and 804; 2) the decode circuitry 840 performs the decode stage 806; 3) the rename/allocator unit circuitry 852 performs the allocation stage 808 and renaming stage 810; 4) the scheduler(s) circuitry 856 performs the schedule stage 812; 5) the physical register file(s) circuitry 858 and the memory unit circuitry 870 perform the register read/memory read stage 814; the execution cluster(s) 860 perform the execute stage 816; 6) the memory unit circuitry 870 and the physical register file(s) circuitry 858 perform the write back/memory write stage 818; 7) various circuitry may be involved in the exception handling stage 822; and 8) the retirement unit circuitry 854 and the physical register file(s) circuitry 858 perform the commit stage 824.

FIG. 8(B) shows a processor core 890 including front-end unit circuitry 830 coupled to execution engine unit circuitry 850, and both are coupled to memory unit circuitry 870. The core 890 may be a reduced instruction set architecture computing (RISC) core, a complex instruction set architecture computing (CISC) core, a very long instruction word (VLIW) core, or a hybrid or alternative core type. As yet another option, the core 890 may be a special-purpose core, such as, for example, a network or communication core, compression engine, coprocessor core, general purpose computing graphics processing unit (GPGPU) core, graphics core, or the like.

The front-end unit circuitry 830 may include branch prediction circuitry 832 coupled to instruction cache circuitry 834, which is coupled to an instruction translation lookaside buffer (TLB) 836, which is coupled to instruction fetch circuitry 838, which is coupled to decode circuitry 840. In one example, the instruction cache circuitry 834 is included in the memory unit circuitry 870 rather than the front-end circuitry 830. The decode circuitry 840 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 840 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 840 may be implemented using various mechanisms. Examples of suitable mechanisms include, but are not limited to, look-up tables, hardware implementations, programmable logic arrays (PLAs), microcode read only memories (ROMs), etc. In one example, the core 890 includes a microcode ROM (not shown) or other medium that stores microcode for certain macroinstructions (e.g., in decode circuitry 840 or otherwise within the front-end circuitry 830). In one example, the decode circuitry 840 includes a micro-operation (micro-op) or operation cache (not shown) to hold/cache decoded operations, micro-tags, or micro-operations generated during the decode or other stages of the processor pipeline 800. The decode circuitry 840 may be coupled to rename/allocator unit circuitry 852 in the execution engine circuitry 850.

The execution engine circuitry 850 includes the rename/allocator unit circuitry 852 coupled to retirement unit circuitry 854 and a set of one or more scheduler(s) circuitry 856. The scheduler(s) circuitry 856 represents any number of different schedulers, including reservations stations, central instruction window, etc. In some examples, the scheduler(s) circuitry 856 can include arithmetic logic unit (ALU) scheduler/scheduling circuitry, ALU queues, address generation unit (AGU) scheduler/scheduling circuitry, AGU queues, etc. The scheduler(s) circuitry 856 is coupled to the physical register file(s) circuitry 858. Each of the physical register file(s) circuitry 858 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 858 includes vector registers unit circuitry, writemask registers unit circuitry, and scalar register unit circuitry. These register units may provide architectural vector registers, vector mask registers, general-purpose registers, etc. The physical register filc(s) circuitry 858 is coupled to the retirement unit circuitry 854 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 854 and the physical register file(s) circuitry 858 are coupled to the execution cluster(s) 860. The execution cluster(s) 860 includes a set of one or more execution unit(s) circuitry 862 and a set of one or more memory access circuitry 864. The execution unit(s) circuitry 862 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include several execution units or execution unit circuitry dedicated to specific functions or sets of functions, other examples may include only one execution unit circuitry or multiple execution units/execution unit circuitry that all perform all functions. The scheduler(s) circuitry 856, physical register file(s) circuitry 858, and execution cluster(s) 860 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 864). It should also be understood that where separate pipelines are used, one or more of these pipelines may be out-of-order issue/execution and the rest in-order.

In some examples, the execution engine unit circuitry 850 may perform load store unit (LSU) address/data pipelining to an Advanced Microcontroller Bus (AMB) interface (not shown), and address phase and writeback, data phase load, store, and branches.

The set of memory access circuitry 864 is coupled to the memory unit circuitry 870, which includes data TLB circuitry 872 coupled to data cache circuitry 874 coupled to level 2 (L2) cache circuitry 876. In one example, the memory access circuitry 864 may include load unit circuitry, store address unit circuitry, and store data unit circuitry, each of which is coupled to the data TLB circuitry 872 in the memory unit circuitry 870. The instruction cache circuitry 834 is further coupled to the level 2 (L2) cache circuitry 876 in the memory unit circuitry 870. In one example, the instruction cache 834 and the data cache 874 are combined into a single instruction and data cache (not shown) in L2 cache circuitry 876, level 3 (L3) cache circuitry (not shown), and/or main memory. The L2 cache circuitry 876 is coupled to one or more other levels of cache and eventually to a main memory.

The core 890 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 890 includes logic to support a packed data instruction set architecture extension (e.g., AVX1, AVX2), thereby allowing the operations used by many multimedia applications to be performed using packed data.

### Example Execution Unit(s) Circuitry

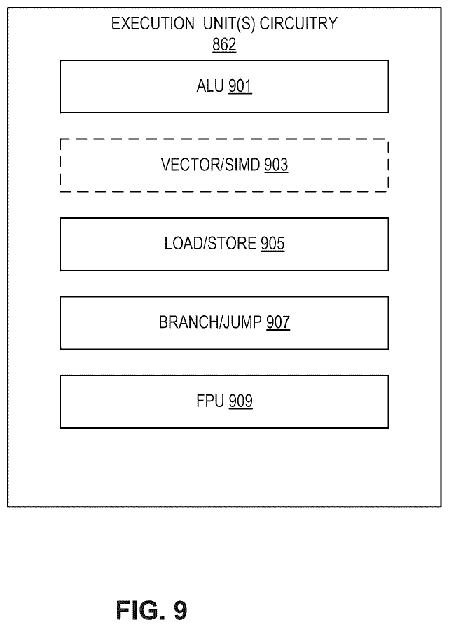

FIG. 9 illustrates examples of execution unit(s) circuitry, such as execution unit(s) circuitry 862 of FIG. 8(B). As illustrated, execution unit(s) circuitry 862 may include one or more ALU circuits 901, optional vector/single instruction multiple data (SIMD) circuits 903, load/store circuits 905, branch/jump circuits 907, and/or Floating-point unit (FPU) circuits 909. ALU circuits 901 perform integer arithmetic and/or Boolean operations. Vector/SIMD circuits 903 perform vector/SIMD operations on packed data (such as SIMD/vector registers). Load/store circuits 905 execute load and store instructions to load data from memory into registers or store from registers to memory. Load/store circuits 905 may also generate addresses. Branch/jump circuits 907 cause a branch or jump to a memory address depending on the instruction. FPU circuits 909 perform floating-point arithmetic. The width of the execution unit(s) circuitry 862 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture

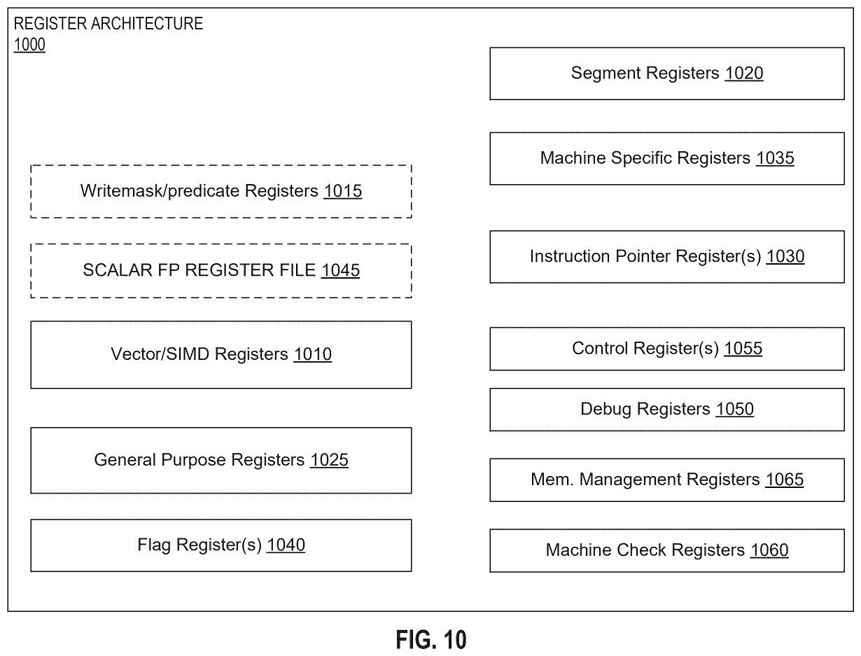

FIG. 10 is a block diagram of a register architecture 1000 according to some examples. As illustrated, the register architecture 1000 includes vector/SIMD registers 1010 that vary from 128-bit to 1,024 bits width. In some examples, the vector/SIMD registers 1010 are physically 512-bits and, depending upon the mapping, only some of the lower bits are used. For example, in some examples, the vector/SIMD registers 1010 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1000 includes writemask/predicate registers 1015. For example, in some examples, there are 8 writemask/predicate registers (sometimes called k0 through k7) that are each 16-bit, 32-bit, 64-bit, or 128-bit in size. Writemask/predicate registers 1015 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1015 corresponds to a data element position of the destination. In other examples, the writemask/predicate registers 1015 are scalable and consists of a set number of enable bits for a given vector element (e.g., 8 enable bits per 64-bit vector element).

The register architecture 1000 includes a plurality of general-purpose registers 1025. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1000 includes scalar floating-point (FP) register file 1045 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1040 (e.g., EFLAGS, RFLAGS, etc.) store status and control information for arithmetic, compare, and system operations. For example, the one or more flag registers 1040 may store condition code information such as carry, parity, auxiliary carry, zero, sign, and overflow. In some examples, the one or more flag registers 1040 are called program status and control registers.

Segment registers 1020 contain segment points for use in accessing memory. In some examples, these registers are referenced by the names CS, DS, SS, ES, FS, and GS.

Machine specific registers (MSRs) 1035 control and report on processor performance. Most MSRs 1035 handle system-related functions and are not accessible to an application program. Machine check registers 1060 consist of control, status, and error reporting MSRs that are used to detect and report on hardware errors.

One or more instruction pointer register(s) 1030 store an instruction pointer value. Control register(s) 1055 (e.g., CR0-CR4) determine the operating mode of a processor (e.g., processor 670, 680, 638, 615, and/or 700) and the characteristics of a currently executing task. Debug registers 1050 control and allow for the monitoring of a processor or core's debugging operations.

Memory (mem) management registers 1065 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 1000 may, for example, be used in register file/memory 'ISAB08, or physical register file(s) circuitry 858.

### Instruction Set Architectures.

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source 1/destination and source 2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

### Example Instruction Formats

Examples of the instruction(s) described herein may be embodied in different formats. Additionally, example systems, architectures, and pipelines are detailed below. Examples of the instruction(s) may be executed on such systems, architectures, and pipelines, but are not limited to those detailed.

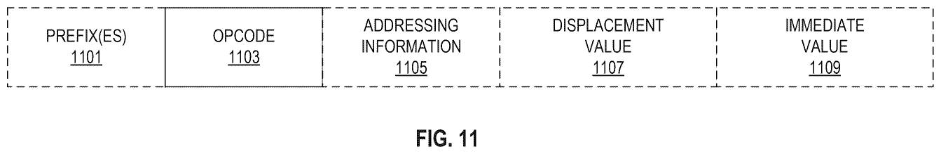

FIG. 11 illustrates examples of an instruction format. As illustrated, an instruction may include multiple components including, but not limited to, one or more fields for: one or more prefixes 1101, an opcode 1103, addressing information 1105 (e.g., register identifiers, memory addressing information, etc.), a displacement value 1107, and/or an immediate value 1109. Note that some instructions utilize some or all the fields of the format whereas others may only use the field for the opcode 1103. In some examples, the order illustrated is the order in which these fields are to be encoded, however, it should be appreciated that in other examples these fields may be encoded in a different order, combined, etc.

The prefix(es) field(s) 1101, when used, modifies an instruction. In some examples, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 1103 is used to at least partially define the operation to be performed upon a decoding of the instruction. In some examples, a primary opcode encoded in the opcode field 1103 is one, two, or three bytes in length. In other examples, a primary opcode can be a different length. An additional 3-bit opcode field is sometimes encoded in another field.

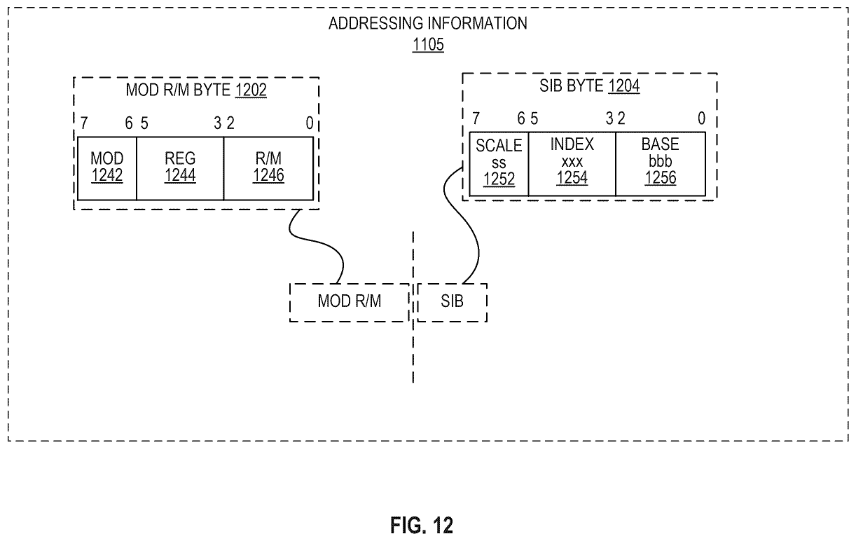

The addressing information field 1105 is used to address one or more operands of the instruction, such as a location in memory or one or more registers. FIG. 12 illustrates examples of the addressing information field 1105. In this illustration, an optional MOD R/M byte 1202 and an optional Scale, Index, Base (SIB) byte 1204 are shown. The MOD R/M byte 1202 and the SIB byte 1204 are used to encode up to two operands of an instruction, each of which is a direct register or effective memory address. Note that both fields are optional in that not all instructions include one or more of these fields. The MOD R/M byte 1202 includes a MOD field 1242, a register (reg) field 1244, and R/M field 1246.

The content of the MOD field 1242 distinguishes between memory access and non-memory access modes. In some examples, when the MOD field 1242 has a binary value of 11 (11b), a register-direct addressing mode is utilized, and otherwise a register-indirect addressing mode is used.

The register field 1244 may encode either the destination register operand or a source register operand or may encode an opcode extension and not be used to encode any instruction operand. The content of register field 1244, directly or through address generation, specifies the locations of a source or destination operand (either in a register or in memory). In some examples, the register field 1244 is supplemented with an additional bit from a prefix (e.g., prefix 1101) to allow for greater addressing.

The R/M field 1246 may be used to encode an instruction operand that references a memory address or may be used to encode either the destination register operand or a source register operand. Note the R/M field 1246 may be combined with the MOD field 1242 to dictate an addressing mode in some examples.

The SIB byte 1204 includes a scale field 1252, an index field 1254, and a base field 1256 to be used in the generation of an address. The scale field 1252 indicates a scaling factor. The index field 1254 specifies an index register to use. In some examples, the index field 1254 is supplemented with an additional bit from a prefix (e.g., prefix 1101) to allow for greater addressing. The base field 1256 specifies a base register to use. In some examples, the base field 1256 is supplemented with an additional bit from a prefix (e.g., prefix 1101) to allow for greater addressing. In practice, the content of the scale field 1252 allows for the scaling of the content of the index field 1254 for memory address generation (e.g., for address generation that uses 2^{scale}*index+base).

Some addressing forms utilize a displacement value to generate a memory address. For example, a memory address may be generated according to 2^{scale}*index+base+displacement, index*scale+displacement, r/m+displacement, instruction pointer (RIP/EIP)+displacement, register+displacement, etc. The displacement may be a 1-byte, 2-byte, 4-byte, etc. value. In some examples, the displacement field 1107 provides this value. Additionally, in some examples, a displacement factor usage is encoded in the MOD field of the addressing information field 1105 that indicates a compressed displacement scheme for which a displacement value is calculated and stored in the displacement field 1107.

In some examples, the immediate value field 1109 specifies an immediate value for the instruction. An immediate value may be encoded as a 1-byte value, a 2-byte value, a 4-byte value, etc.

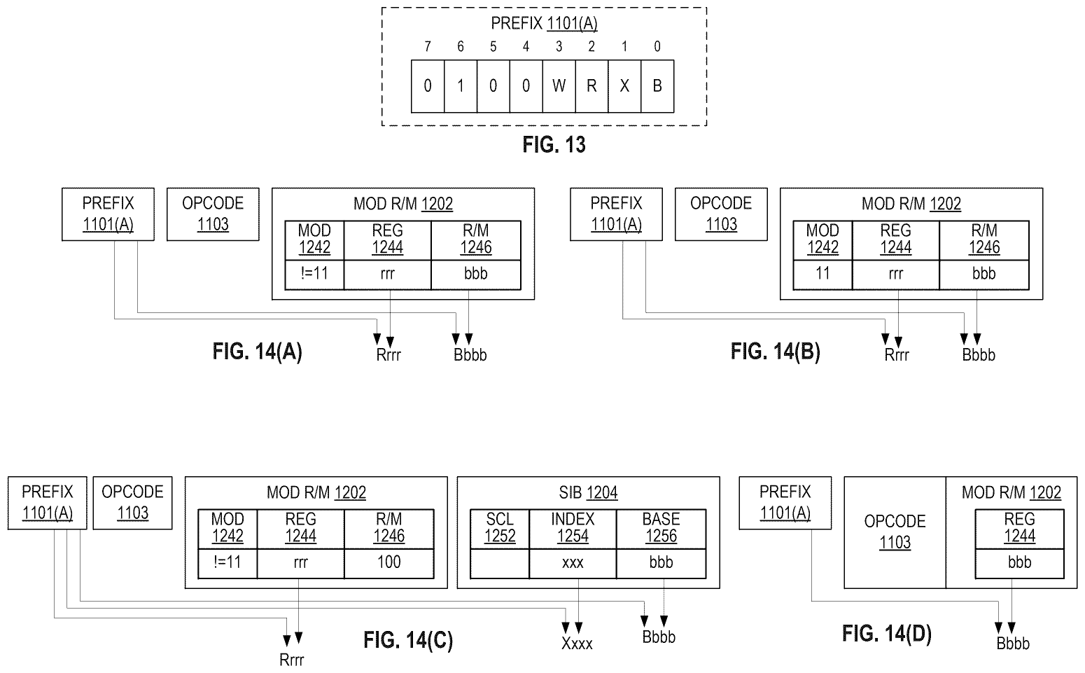

FIG. 13 illustrates examples of a first prefix 1101(A). In some examples, the first prefix 1101(A) is an example of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 1101(A) may specify up to three registers using 3-bit fields depending on the format: 1) using the reg field 1244 and the R/M field 1246 of the MOD R/M byte 1202; 2) using the MOD R/M byte 1202 with the SIB byte 1204 including using the reg field 1244 and the base field 1256 and index field 1254; or 3) using the register field of an opcode.

In the first prefix 1101(A), bit positions 7:4 are set as 0100. Bit position 3 (W) can be used to determine the operand size but may not solely determine operand width. As such, when W=0, the operand size is determined by a code segment descriptor (CS.D) and when W=1, the operand size is 64-bit.

Note that the addition of another bit allows for 16 (24) registers to be addressed, whereas the MOD R/M reg field 1244 and MOD R/M R/M field 1246 alone can each only address 8 registers.

In the first prefix 1101(A), bit position 2 (R) may be an extension of the MOD R/M reg field 1244 and may be used to modify the MOD R/M reg field 1244 when that field encodes a general-purpose register, a 64-bit packed data register (e.g., an SSE register), or a control or debug register. R is ignored when MOD R/M byte 1202 specifies other registers or defines an extended opcode.

Bit position 1 (X) may modify the SIB byte index field 1254.

Bit position 0 (B) may modify the base in the MOD R/M R/M field 1246 or the SIB byte base field 1256; or it may modify the opcode register field used for accessing general purpose registers (e.g., general purpose registers 1025).

FIGS. 14(A)-(D) illustrate examples of how the R, X, and B fields of the first prefix 1101(A) are used. FIG. 14(A) illustrates R and B from the first prefix 1101(A) being used to extend the reg field 1244 and R/M field 1246 of the MOD R/M byte 1202 when the SIB byte 12 04 is not used for memory addressing. FIG. 14(B) illustrates R and B from the first prefix 1101(A) being used to extend the reg field 1244 and R/M field 1246 of the MOD R/M byte 1202 when the SIB byte 1204 is not used (register-register addressing). FIG. 14(C) illustrates R, X, and B from the first prefix 1101(A) being used to extend the reg field 1244 of the MOD R/M byte 1202 and the index field 1254 and base field 1256 when the SIB byte 1204 being used for memory addressing. FIG. 14(D) illustrates B from the first prefix 1101(A) being used to extend the reg field 1244 of the MOD R/M byte 1202 when a register is encoded in the opcode 1103.

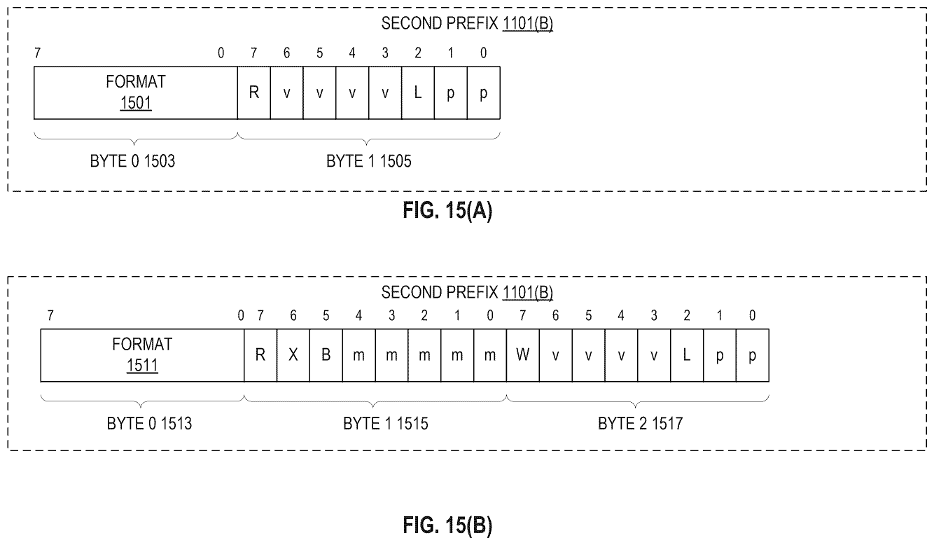

FIGS. 15(A)-(B) illustrate examples of a second prefix 1101(B). In some examples, the second prefix 1101(B) is an example of a VEX prefix. The second prefix 1101(B) encoding allows instructions to have more than two operands, and allows SIMD vector registers (e.g., vector/SIMD registers 1010) to be longer than 64-bits (e.g., 128-bit and 256-bit). The use of the second prefix 1101(B) provides for three-operand (or more) syntax. For example, previous two-operand instructions performed operations such as A=A+B, which overwrites a source operand. The use of the second prefix 1101(B) enables operands to perform nondestructive operations such as A=B+C.

In some examples, the second prefix 1101(B) comes in two forms-a two-byte form and a three-byte form. The two-byte second prefix 1101(B) is used mainly for 128-bit, scalar, and some 256-bit instructions; while the three-byte second prefix 1101(B) provides a compact replacement of the first prefix 1101(A) and 3-byte opcode instructions.

FIG. 15(A) illustrates examples of a two-byte form of the second prefix 1101(B). In one example, a format field 1501 (byte 0 1503) contains the value C5H. In one example, byte 1 1505 includes an “R” value in bit [7]. This value is the complement of the “R” value of the first prefix 1101(A). Bit [2] is used to dictate the length (L) of the vector (where a value of 0 is a scalar or 128-bit vector and a value of 1 is a 256-bit vector). Bits [1:0] provide opcode extensionality equivalent to some legacy prefixes (e.g., 00=no prefix, 01=66H, 10=F3H, and 11=F2H). Bits [6:3] shown as vvvv may be used to: 1) encode the first source register operand, specified in inverted (Is complement) form and valid for instructions with 2 or more source operands; 2) encode the destination register operand, specified in Is complement form for certain vector shifts; or 3) not encode any operand, the field is reserved and should contain a certain value, such as 1111b.

Instructions that use this prefix may use the MOD R/M R/M field 1246 to encode the instruction operand that references a memory address or encode either the destination register operand or a source register operand.

Instructions that use this prefix may use the MOD R/M reg field 1244 to encode either the destination register operand or a source register operand, or to be treated as an opcode extension and not used to encode any instruction operand.

For instruction syntax that supports four operands, vvvv, the MOD R/M R/M field 1246 and the MOD R/M reg field 1244 encode three of the four operands. Bits [7:4] of the immediate value field 1109 are then used to encode the third source register operand.

FIG. 15(B) illustrates examples of a three-byte form of the second prefix 1101(B). In one example, a format field 1511 (byte 0 1513) contains the value C4H. Byte 1 1515 includes in bits [7:5] “R,” “X,” and “B” which are the complements of the same values of the first prefix 1101(A). Bits [4:0] of byte 1 1515 (shown as mmmmm) include content to encode, as need, one or more implied leading opcode bytes. For example, 00001 implies a OFH leading opcode, 00010 implies a 0F38H leading opcode, 00011 implies a 0F3AH leading opcode, etc.

Bit [7] of byte 2 1517 is used like W of the first prefix 1101(A) including helping to determine promotable operand sizes. Bit [2] is used to dictate the length (L) of the vector (where a value of 0 is a scalar or 128-bit vector and a value of 1 is a 256-bit vector). Bits [1:0] provide opcode extensionality equivalent to some legacy prefixes (e.g., 00=no prefix, 01=66H, 10=F3H, and 11=F2H). Bits [6:3], shown as vvvv, may be used to: 1) encode the first source register operand, specified in inverted (Is complement) form and valid for instructions with 2 or more source operands; 2) encode the destination register operand, specified in Is complement form for certain vector shifts; or 3) not encode any operand, the field is reserved and should contain a certain value, such as 1111b.

Instructions that use this prefix may use the MOD R/M R/M field 1246 to encode the instruction operand that references a memory address or encode either the destination register operand or a source register operand.

Instructions that use this prefix may use the MOD R/M reg field 1244 to encode either the destination register operand or a source register operand, or to be treated as an opcode extension and not used to encode any instruction operand.

For instruction syntax that supports four operands, vvvv, the MOD R/M R/M field 1246, and the MOD R/M reg field 1244 encode three of the four operands. Bits [7:4] of the immediate value field 1109 are then used to encode the third source register operand.

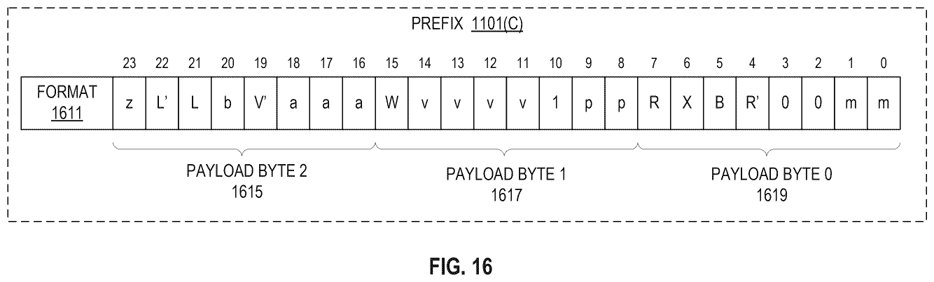

FIG. 16 illustrates examples of a third prefix 1101(C). In some examples, the third prefix 1101(C) is an example of an EVEX prefix. The third prefix 1101(C) is a four-byte prefix.

The third prefix 1101(C) can encode 32 vector registers (e.g., 128-bit, 256-bit, and 512-bit registers) in 64-bit mode. In some examples, instructions that utilize a writemask/opmask (see discussion of registers in a previous figure, such as FIG. 10) or predication utilize this prefix. Opmask register allows for conditional processing or selection control. Opmask instructions, whose source/destination operands are opmask registers and treat the content of an opmask register as a single value, are encoded using the second prefix 1101(B).

The third prefix 1101(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 1101(C) is a format field 1611 that has a value, in one example, of 62H. Subsequent bytes are referred to as payload bytes 1615-1619 and collectively form a 24-bit value of P[23:0] providing specific capability in the form of one or more fields (detailed herein).

In some examples, P[1:0] of payload byte 1619 are identical to the low two mm bits. P[3:2] are reserved in some examples. Bit P[4] (R′) allows access to the high 16 vector register set when combined with P[7] and the MOD R/M reg field 1244. P[6] can also provide access to a high 16 vector register when SIB-type addressing is not needed. P[7:5] consist of R, X, and B which are operand specifier modifier bits for vector register, general purpose register, memory addressing and allow access to the next set of 8 registers beyond the low 8 registers when combined with the MOD R/M register field 1244 and MOD R/M R/M field 1246. P[9:8] provides opcode extensionality equivalent to some legacy prefixes (e.g., 00=no prefix, 01=66H, 10=F3H, and 11=F2H). P[10] in some examples is a fixed value of 1. P[14:11], shown as vvvv, may be used to: 1) encode the first source register operand, specified in inverted (1s complement) form and valid for instructions with 2 or more source operands; 2) encode the destination register operand, specified in Is complement form for certain vector shifts; or 3) not encode any operand, the field is reserved and should contain a certain value, such as 1111b.

P[15] is like W of the first prefix 1101(A) and second prefix 1111(B) and may serve as an opcode extension bit or operand size promotion.

P[18:16] specify the index of a register in the opmask (writemask) registers (e.g., writemask/predicate registers 1015). In one example, the specific value aaa=000 has a special behavior implying no opmask is used for the particular instruction (this may be implemented in a variety of ways including the use of an opmask hardwired to all ones or hardware that bypasses the masking hardware). When merging, vector masks allow any set of elements in the destination to be protected from updates during the execution of any operation (specified by the base operation and the augmentation operation); in other one example, preserving the old value of each element of the destination where the corresponding mask bit has a 0. In contrast, when zeroing vector masks allow any set of elements in the destination to be zeroed during the execution of any operation (specified by the base operation and the augmentation operation); in one example, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While examples are described in which the opmask field's content selects one of a number of opmask registers that contains the opmask to be used (and thus the opmask field's content indirectly identifies that masking to be performed), alternative examples instead or additional allow the mask write field's content to directly specify the masking to be performed.

P[19] can be combined with P[14:11] to encode a second source vector register in a non-destructive source syntax which can access an upper 16 vector registers using P[19]. P[20] encodes multiple functionalities, which differ across different classes of instructions and can affect the meaning of the vector length/rounding control specifier field (P[22:21]). P[23] indicates support for merging-writemasking (e.g., when set to 0) or support for zeroing and merging-writemasking (e.g., when set to 1).

Example examples of encoding of registers in instructions using the third prefix 1101(C) are detailed in the following tables.

TABLE 1
32-Register Support in 64-bit Mode

| | | | | REG. | |
|---|---|---|---|---|---|
| | 4 | 3 | [2:0] | TYPE | COMMON USAGES |
| REG | R′ | R | MOD R/M | GPR, Vector | Destination or Source |
| | | | reg | | |
| VVVV | V′ | vvvv | | GPR, Vector | 2nd Source or |
| | | | | | Destination |
| RM | X | B | MOD R/M | GPR, Vector | 1st Source or |
| | | | R/M | | Destination |
| BASE | 0 | B | MOD R/M | GPR | Memory addressing |
| | | | R/M | | |
| INDEX | 0 | X | SIB.index | GPR | Memory addressing |
| VIDX | V′ | X | SIB.index | Vector | VSIB memory |
| | | | | | addressing |

TABLE 2
Encoding Register Specifiers in 32-bit Mode

| | [2:0] | REG. TYPE | COMMON USAGES |
|---|---|---|---|
| REG | MOD R/M reg | GPR, Vector | Destination or Source |
| VVVV | vvvv | GPR, Vector | 2^{nd} Source or Destination |
| RM | MOD R/M R/M | GPR, Vector | 1^{st} Source or Destination |
| BASE | MOD R/M R/M | GPR | Memory addressing |
| INDEX | SIB.index | GPR | Memory addressing |
| VIDX | SIB.index | Vector | VSIB memory addressing |

TABLE 3
Opmask Register Specifier Encoding

| | [2:0] | REG. TYPE | COMMON USAGES |
|---|---|---|---|
| REG | MOD R/M Reg | k0-k7 | Source |
| VVVV | vvvv | k0-k7 | 2^{nd} Source |
| RM | MOD R/M R/M | k0-k7 | 1^{st} Source |
| {k1} | aaa | k0-k7 | Opmask |

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “intellectual property (IP) cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors, and/or system features described herein. Such examples may also be referred to as program products.

### Emulation (Including Binary Translation, Code Morphing, Etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

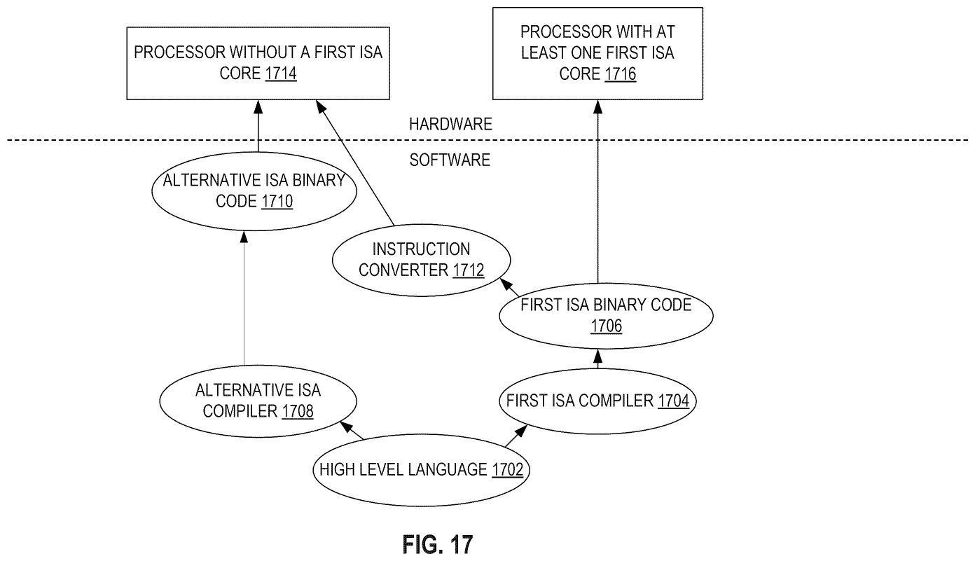

FIG. 17 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 17 shows a program in a high-level language 1702 may be compiled using a first ISA compiler 1704 to generate first ISA binary code 1706 that may be natively executed by a processor with at least one first ISA core 1716. The processor with at least one first ISA core 1716 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 1704 represents a compiler that is operable to generate the first ISA binary code 1706 (e.g., object code) that can, with or without additional linkage processing, be executed on the processor with at least one first ISA core 1716. Similarly, FIG. 17 shows the program in the high-level language 1702 may be compiled using an alternative ISA compiler 1708 to generate alternative ISA binary code 1710 that may be natively executed by a processor without a first ISA core 1714. The instruction converter 1712 is used to convert the first ISA binary code 1706 into code that may be natively executed by the processor without a first ISA core 1714. This converted code is not necessarily to be the same as the alternative ISA binary code 1710; however, the converted code will accomplish the general operation and be made up of instructions from the alternative ISA. Thus, the instruction converter 1712 represents software, firmware, hardware, or a combination thereof that, through emulation, simulation, or any other process, allows a processor or other electronic device that does not have a first ISA processor or core to execute the first ISA binary code 1706.

Components, features, and details described for any of FIGS. 3-5 may also optionally apply to any of FIGS. 1-2. Components, features, and details described for any of the processors disclosed herein (e.g., processor 210, processor 310) may optionally apply to any of the methods disclosed herein (e.g., method 100), which in embodiments may optionally be performed by and/or with such processors. Any of the processors described herein (e.g., processor 210, processor 310) in embodiments may optionally be included in any of the systems disclosed herein. Any of the processors disclosed herein (e.g., processor 210, processor 310) may optionally have any of the microarchitectures shown herein.

References to “one example,” “an example,” etc., indicate that the example described may include a particular feature, structure, or characteristic, but every example may not necessarily include the particular feature, structure, or characteristic. Moreover, such phrases do not necessarily refer to the same example. Further, when a particular feature, structure, or characteristic is described in connection with an example, it is submitted that it is within the knowledge of one skilled in the art to affect such feature, structure, or characteristic in connection with other examples whether explicitly described.

Processor components disclosed herein may be said and/or claimed to be operative, operable, capable, able, configured adapted, or otherwise to perform an operation. For example, a decoder may be said and/or claimed to decode an instruction, an execution unit may be said and/or claimed to store a result, or the like. As used herein, these expressions refer to the characteristics, properties, or attributes of the components when in a powered-off state, and do not imply that the components or the device or apparatus in which they are included is currently powered on or operating. For clarity, it is to be understood that the processors and apparatus claimed herein are not claimed as being powered on or running.

In the description and claims, the terms “coupled” and/or “connected,” along with their derivatives, may have been used. These terms are not intended as synonyms for each other. Rather, in embodiments, “connected” may be used to indicate that two or more elements are in direct physical and/or electrical contact with each other. “Coupled” may mean that two or more elements are in direct physical and/or electrical contact with each other. However, “coupled” may also mean that two or more elements are not in direct contact with each other, yet still co-operate or interact with each other. For example, an execution unit may be coupled with a register and/or a decode unit through one or more intervening components. In the figures, arrows are used to show connections and couplings.

Some embodiments include an article of manufacture (e.g., a computer program product) that includes a machine-readable medium. The medium may include a mechanism that provides, for example stores, information in a form that is readable by the machine. The machine-readable medium may provide, or have stored thereon, an instruction or sequence of instructions, that if and/or when executed by a machine are operative to cause the machine to perform and/or result in the machine performing one or operations, methods, or techniques disclosed herein.

In some embodiments, the machine-readable medium may include a tangible and/or non-transitory machine-readable storage medium. For example, the non-transitory machine-readable storage medium may include a floppy diskette, an optical storage medium, an optical disk, an optical data storage device, a CD-ROM, a magnetic disk, a magneto-optical disk, a read only memory (ROM), a programmable ROM (PROM), an erasable-and-programmable ROM (EPROM), an electrically-erasable-and-programmable ROM (EEPROM), a random access memory (RAM), a static-RAM (SRAM), a dynamic-RAM (DRAM), a Flash memory, a phase-change memory, a phase-change data storage material, a non-volatile memory, a non-volatile data storage device, a non-transitory memory, a non-transitory data storage device, or the like. The non-transitory machine-readable storage medium does not consist of a transitory propagated signal. In some embodiments, the storage medium may include a tangible medium that includes solid-state matter or material, such as, for example, a semiconductor material, a phase change material, a magnetic solid material, a solid data storage material, etc. Alternatively, a non-tangible transitory computer-readable transmission media, such as, for example, an electrical, optical, acoustical, or other form of propagated signals-such as carrier waves, infrared signals, and digital signals, may optionally be used.

Examples of suitable machines include, but are not limited to, a general-purpose processor, a special-purpose processor, a digital logic circuit, an integrated circuit, or the like. Still other examples of suitable machines include a computer system or other electronic device that includes a processor, a digital logic circuit, or an integrated circuit. Examples of such computer systems or electronic devices include, but are not limited to, desktop computers, laptop computers, notebook computers, tablet computers, netbooks, smartphones, cellular phones, servers, network devices (e.g., routers and switches), Mobile Internet devices (MIDs), media players, smart televisions, nettops, set-top boxes, and video game controllers.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e., A and B, A and C, B and C, and A, B and C).

In the description above, specific details have been set forth to provide a thorough understanding of the embodiments. However, other embodiments may be practiced without some of these specific details. Various modifications and changes may be made thereunto without departing from the broader spirit and scope of the disclosure as set forth in the claims. The specification and drawings are, accordingly, to be regarded in an illustrative rather than a restrictive sense. The scope of the invention is not to be determined by the specific examples provided above, but only by the claims below. In other instances, well-known circuits, structures, devices, and operations have been shown in block diagram form and/or without detail to avoid obscuring the understanding of the description.

### Example Embodiments

The following examples pertain to further embodiments. Specifics in the examples may be used anywhere in one or more embodiments.

Example 1 is a method including processing instructions with a processor, making predictions associated with some of the instructions based on prediction state, clearing a plurality of subsets of the prediction state sequentially, and continuing the processing of the instructions while the plurality of the subsets of the prediction state are being cleared.

Example 2 includes the method of Example 1, where continuing the processing of the instructions, while the plurality of the subsets of the prediction state are being cleared, includes fetching an instruction, decoding the instruction, and performing operations corresponding to the instruction.

Example 3 includes the method of any one of Examples 1 to 2, where clearing the plurality of the subsets of the prediction state sequentially includes clearing plurality of the entries of an array or table of prediction state sequentially.

Example 4 includes the method of any one of Examples 1 to 3, further including controlling how predictions are made while the plurality of the subsets of the prediction state are cleared sequentially.

Example 5 includes the method of Example 4, where the controlling how the predictions are made while the plurality of the subsets of the prediction state are cleared sequentially includes preventing the predictions from being made based on the prediction state.

Example 6 is a processor or other apparatus including a front-end unit to obtain and decode instructions. The front-end unit includes a prediction unit having storage to store prediction state, the prediction unit to make predictions associated with some of the instructions based on the prediction state. The front-end unit also includes circuitry to sequentially clear plurality of the subsets of the prediction state. The processor or apparatus also includes a back-end unit coupled with the front-end unit. The back-end unit is to execute and commit the instructions. The processor is to continue to process the instructions, while the plurality of the subsets of the prediction state are being cleared.

Example 7 includes the processor of Example 6, where the circuitry, to sequentially clear the plurality of the subsets of the prediction state, is to sequentially clear a plurality of entries of an array or table of prediction state.

Example 8 includes the processor of any one of Examples 6 to 7, where the circuitry is to start to sequentially clear the plurality of the subsets of the prediction state in response to a switch to a different context or mode.

Example 9 includes the processor of any one of Examples 6 to 8, where the circuitry, to sequentially clear the plurality of the subsets of the prediction state, is to cause the plurality of the subsets of the prediction state to have an initialization state.

Example 10 includes the processor of any one of Examples 6 to 9, further including second circuitry to control how the prediction unit is to make predictions, while the plurality of the subsets of the prediction state are being sequentially cleared.

Example 11 includes the processor of Example 10, where the second circuitry, to control how the prediction unit is to make the predictions, is to prevent the prediction unit from making predictions based on the prediction state, while the plurality of the subsets of the prediction state are being sequentially cleared.

Example 12 includes the processor of Example 11, where the second circuitry, to prevent the prediction unit from making the predictions based on the prediction state, is to force the prediction unit to make predictions that are inconsistent with the prediction state, while the plurality of the subsets of the prediction state are being sequentially cleared.

Example 13 includes the processor of any one of Examples 11 to 12, where the prediction unit is to make the predictions when tag matches are detected for the prediction state, also optionally where the second circuitry, to prevent the prediction unit from making the predictions based on the prediction state, is to force the prediction unit to make predictions as if no tag matches are detected, while the plurality of the subsets of the prediction state are being sequentially cleared.

Example 14 includes the processor of any one of Examples 6 to 13, where the front-end unit includes an instruction fetch unit and an instruction decode unit coupled with the instruction fetch unit and the back-end unit includes at least one execution unit coupled with the instruction decode unit. Also optionally where, while the plurality of the subsets of the prediction state are being sequentially cleared, the instruction fetch unit is to fetch an instruction, the instruction decode unit is to decode the instruction, and the at least one execution unit is to perform operations corresponding to the instruction.

Example 15 includes the processor of any one of Examples 6 to 14, where the front-end unit includes an instruction translation lookaside buffer (TLB) and a memory management unit (MMU) coupled with the instruction TLB. Also optionally where, while the plurality of the subsets of the prediction state are being sequentially cleared, the MMU is to perform at least part of a page table walk to translate a virtual address of a set of instructions to a corresponding physical address in response to a miss in the instruction TLB.

Example 16 includes the processor of any one of Examples 6 to 15, where the front-end unit includes an instruction cache. Also optionally where, while the plurality of the subsets of the prediction state are being sequentially cleared, the instruction cache is to issue a cache fill request for a cacheline of instructions.

Example 17 includes the processor of any one of Examples 6 to 16, where the prediction unit is either a branch prediction unit for which the prediction state includes branch prediction state or a memory renaming predictor.

Example 18 includes the processor of Example 17, where the prediction unit is the branch prediction unit. Also optionally where the branch prediction unit is selected from a group consisting of a conditional branch predictor, an indirect branch predictor, and a branch target buffer.

Example 19 is a computer system or other system including a processor. The processor including a prediction unit to make predictions using prediction state, a fetch unit to fetch instructions based on the predictions, a decode unit to decode the instructions, a plurality of execution units to perform operations corresponding to the instructions, and circuitry to sequentially clear a plurality of subsets of the prediction state. While the plurality of the subsets of the prediction state are being sequentially cleared, the fetch unit is to fetch additional instructions, the decode unit is to decode the additional instructions, and the plurality of execution units are to perform operations corresponding to the additional instructions. The system also includes other components such as a dynamic random access memory (DRAM) coupled with the processor.

Example 20 includes the system of Example 19, where the processor further includes second circuitry to control how the prediction unit is makes the predictions, while the plurality of the subsets of the prediction state are being sequentially cleared.

Example 21 is a processor or other apparatus operative to perform the method of any one of Examples 1 to 5.

Example 22 is a processor or other apparatus that includes means for performing the method of any one of Examples 1 to 5.

Example 23 is a processor or other apparatus that includes any combination of modules and/or units and/or logic and/or circuitry and/or means operative to perform the method of any one of Examples 1 to 5.

Example 24 is an optionally non-transitory and/or tangible machine-readable medium, which optionally stores or otherwise provides instructions including a first instruction, the first instruction if and/or when executed by a processor, computer system, electronic device, or other machine, is operative to cause the machine to perform the method of any one of Examples 1 to 5.

What is claimed is:

1. A method comprising:
processing instructions with a processor;
making predictions associated with some of the instructions based on prediction state;
clearing a plurality of subsets of the prediction state sequentially; and
continuing the processing of the instructions while the plurality of the subsets of the prediction state are being cleared.

2. The method of claim 1, wherein said making the predictions comprises making branch predictions, and wherein continuing the processing of the instructions, while the plurality of the subsets of the prediction state are being cleared, comprises fetching an instruction, decoding the instruction, and performing operations corresponding to the instruction.

3. The method of claim 1, wherein clearing the plurality of the subsets of the prediction state sequentially comprises clearing a plurality of entries of an array or table of prediction state sequentially.

4. The method of claim 1, further comprising controlling how predictions are made while the plurality of the subsets of the prediction state are cleared sequentially.

5. The method of claim 4, wherein the controlling how the predictions are made while the plurality of the subsets of the prediction state are cleared sequentially comprises preventing the predictions from being made based on the prediction state.

6. A processor comprising:
a front-end unit to obtain and decode instructions, the front-end unit including:
a prediction unit having storage to store prediction state, the prediction unit to make predictions associated with some of the instructions based on the prediction state; and
circuitry to sequentially clear a plurality of subsets of the prediction state; and
a back-end unit coupled with the front-end unit, the back-end unit to execute and commit the instructions,
wherein the processor is to continue to process the instructions, while the plurality of the subsets of the prediction state are being cleared.

7. The processor of claim 6, wherein the circuitry, to sequentially clear the plurality of the subsets of the prediction state, is to sequentially clear a plurality of entries of an array or table of prediction state.

8. The processor of claim 6, wherein the circuitry is to start to sequentially clear the plurality of the subsets of the prediction state in response to a switch to a different context or mode.

9. The processor of claim 6, wherein the circuitry, to sequentially clear the plurality of the subsets of the prediction state, is to cause the plurality of the subsets of the prediction state to have an initialization state.

10. The processor of claim 6, further comprising second circuitry to control how the prediction unit is to make predictions, while the plurality of the subsets of the prediction state are being sequentially cleared.

11. The processor of claim 10, wherein the second circuitry, to control how the prediction unit is to make the predictions, is to prevent the prediction unit from making predictions based on the prediction state, while the plurality of the subsets of the prediction state are being sequentially cleared.

12. The processor of claim 11, wherein the second circuitry, to prevent the prediction unit from making the predictions based on the prediction state, is to force the prediction unit to make predictions that are inconsistent with the prediction state, while the plurality of the subsets of the prediction state are being sequentially cleared.

13. The processor of claim 11, wherein the prediction unit is to make the predictions when tag matches are detected for the prediction state, and wherein the second circuitry, to prevent the prediction unit from making the predictions based on the prediction state, is to force the prediction unit to make predictions as if no tag matches are detected, while the plurality of the subsets of the prediction state are being sequentially cleared.

14. The processor of claim 6, wherein the front-end unit includes an instruction fetch unit and an instruction decode unit coupled with the instruction fetch unit, wherein the back-end unit includes at least one execution unit coupled with the instruction decode unit, and wherein, while the plurality of the subsets of the prediction state are being sequentially cleared, the instruction fetch unit is to fetch an instruction, the instruction decode unit is to decode the instruction, and the at least one execution unit is to perform operations corresponding to the instruction.

15. The processor of claim 6, wherein the front-end unit includes an instruction translation lookaside buffer (TLB) and a memory management unit (MMU) coupled with the instruction TLB, and wherein, while the plurality of the subsets of the prediction state are being sequentially cleared, the MMU is to perform at least part of a page table walk to translate a virtual address of a set of instructions to a corresponding physical address in response to a miss in the instruction TLB.

16. The processor of claim 6, wherein the front-end unit includes an instruction cache, and wherein, while the plurality of the subsets of the prediction state are being sequentially cleared, the instruction cache is to issue a cache fill request for a cacheline of instructions.

17. The processor of claim 6, wherein the prediction unit is either a branch prediction unit for which the prediction state comprises branch prediction state or a memory renaming predictor.

18. The processor of claim 17, wherein the prediction unit is the branch prediction unit, and wherein the branch prediction unit is selected from a group consisting of a conditional branch predictor, an indirect branch predictor, and a branch target buffer.

19. A system comprising:
a processor, the processor comprising:
a prediction unit to make predictions using prediction state;
a fetch unit to fetch instructions based on the predictions;
a decode unit to decode the instructions;
a plurality of execution units to perform operations corresponding to the instructions; and
circuitry to sequentially clear a plurality of subsets of the prediction state,
wherein, while the plurality of the subsets of the prediction state are being sequentially cleared, the fetch unit is to fetch additional instructions, the decode unit is to decode the additional instructions, and the plurality of execution units are to perform operations corresponding to the additional instructions; and
a dynamic random access memory (DRAM) coupled with the processor.

20. The system of claim 19, wherein the processor further comprises second circuitry to control how the prediction unit is makes the predictions, while the plurality of the subsets of the prediction state are being sequentially cleared.
